(19) United States
(12) Patent Application Publication
(10) Pub. No.: US 2011/0058129 A1
(43) Pub. Date: Mar. 10, 2011

(54) POLARIZING PLATE AND LIQUID CRYSTAL DISPLAY DEVICE

(75) Inventors: Nobuo Kubo, Tokyo (JP); Masataka Takimoto, Tokyo (JP); Takashi Takebe, Tokyo (JP)

(73) Assignee: KONICA MINOLTA OPTO, INC., Tokyo (JP)

(21) Appl. No.: 12/991,136

(22) PCT Filed: Apr. 24, 2009
(86) PCT No.: PCT/JP2009/058153

§ 371 Date: Nov. 5, 2010

(30) Foreign Application Priority Data
May 12, 2008 (JP) 2008-124542

(51) Int. Cl. G02F 1/1335; G02B 1/08

(52) U.S. Cl. 349/96; 359/492.01

(57) ABSTRACT

Disclosed are a polarizing plate for liquid crystal display having excellent durability, and a liquid crystal display device using the polarizing plate. The polarizing plate is characterized by comprising, at least on one side thereof; an acrylic resin-containing film which contains an acrylic resin (A) and a cellulose ester resin (B) at a mass ratio of from 95:5 to 30:70 in a miscible state. The acrylic resin (A) has a weight average molecular weight Mw of not less than 80,000. The cellulose ester resin (B) has a total substitution degree (T) of acyl groups of 2.00-3.00 and a substitution degree of acyl groups having 3-7 carbon atoms of 1.2-3.0. The cellulose ester resin (B) has a weight average molecular weight Mw of not less than 75,000.

### TECHNICAL FIELD

The present invention relates to a polarizing plate and a liquid crystal display device.

### BACKGROUND

Polymethyl methacrylate (hereinafter referred to as PMMA), which represents the conventional acrylic resins, has been suitably used for optical films due to its excellent transparency, dimensional stability, and low hygroscopicity.

However, there have been noted such problems that PMMA films exhibit poor heat resistance and their shape is deformed in use in high temperatures and over long-term use.

Such problems have been critical with respect to physical properties of simple films as well as in polarizing plates and liquid crystal display devices using such films. Namely, the following problems have been produced: in a liquid crystal display device, with deformation of a film, a polarizing plate is curled, whereby the entire panel is bent, and during use in the position of the viewing side surface, the design retardation tends to be changed, whereby viewing angel changes and color shade changes occur.

To improve heat resistance, a method to add polycarbonate (hereinafter referred to as PC) to an acrylic resin has been proposed. However, usable solvents are limited and also miscibility between the resins is inadequate, whereby cloudiness tends to occur, resulting in the difficulty of use as an optical film (for example, refer to Patent Document 1).

Disclosed are a method to introduce an alicyclic alkyl group as a copolymerization component of an acrylic resin; and a method to form a cyclic structure in the molecular main chain via intramolecular cyclization reaction (for example, refer to Patent Documents 2, 3, and 4).

However, in these methods, heat resistance is improved but film brittleness is markedly degraded. Such brittleness degradation accelerates panel deformation and eventually retardation changes cannot be inhibited. As a result, problems with respect to viewing angle changes and color shade changes have not yet been overcome.

Further, with the increased size of displays, realization of thinner members, and weight reduction, these problems with respect to transparency, enhanced heat resistance, and brittleness have been more pronounced.

Over recent years, liquid crystal display devices have been frequently employed for car-interior use and for mobile cellular phones. Their reliability in high temperatures and under high temperature/humidity conditions is strongly demanded. Further, usage in large-sized high vision TV sets is becoming popular, whereby uniformity in the screen and the durability of display quality with respect to color tone and contrast are being demanded.

A liquid crystal display device is commonly used with a form in which a polarizing plate is bonded to one side or both sides of a liquid crystal cell for display. For this polarizing plate, there are commonly used those produced in such a manner that a cellulose-based resin film whose typical example is triacetyl cellulose (TAC) is allowed to adhere to both sides of a polarizer produced by adsorbing iodine or a dichroic dye to a polyvinyl alcohol film, followed by being stretched and oriented.

A cellulose-based resin is characterized by usually exhibiting large moisture permeability and by easily allowing moisture to pass therethrough, whereby such problems have been noted that exposure under an ambience of humidity and heat resistance causes color fading of a polarizer due to humidity, resulting in color hue changes and a decrease in the degree of polarization. To solve such problems, the moisture permeability of a polarizing plate protective film is allowed to decrease. Specifically, a protective film itself is changed to a resin exhibiting smaller moisture permeability than a cellulose-based resin, or via surface treatment on the exposed surface of a cellulose-based resin, the moisture permeability of a protective film is allowed to decrease.

As a technology of constituting such a protective film itself with a resin of small moisture permeability, the following description is made: a uniaxially-stretched polymer film of a moisture permeability of at most 10 g/m²-day, specifically a uniaxially-stretched high-density polyethylene film or polypropylene film is arranged as a protective film on both sides of a polyvinyl alcohol-based polarizer of a moisture percentage of at most 5%, whereby the durability of a polarizing plate is improved (for example, refer to Patent Document 5). It is described that a transparent protective film having a moisture permeability of at most 55 g/m²-r at a temperature of 80° C. and a relative humidity of 95%, as well as having a dimensional change rate of −0.3%-0% after heating at 100° C. for 30 minutes, specifically a polymethyl methacrylate, polyether sulfone, or poly carbonate film is arranged at least on one side of a polyvinyl alcohol polarizer, whereby the durability of a polarizing plate is also improved (for example, refer to Patent Document 6). A film constituted of only polymethyl methacrylate is fragile and thereby is not preferable as a polarizing plate protective film, exhibiting also poor heat resistance. Polyether sulfone or poly carbonate exhibits larger refractive index than glass or a substrate used for a liquid crystal display cell, whereby no displaying in response to a display signal has been frequently carried out due to interference or reflection.

Further, it is described that a protective film of a moisture permeability of at most 200 g/m²-24 hr 100 μm at a temperature of 80° C. and a relative humidity of 90%, specifically a thermoplastic saturated norbomene resin film is bonded to at least one side of a polyvinyl alcohol-based polarizer, whereby the durability of a polarizing plate is also improved (for example, refer to Patent Document 7).

Still further, a cellulose ester film is disclosed in which as a plasticizer blended in a cellulose ester, a rosin resin, epoxy resin, ketone resin, or toluene sulfone amide resin is used, whereby mass changes are allowed to be 0-2% and further moisture permeability is allowed to be 50-250 g/m².24 hr in cases where 48-hour treatment is carried out under an ambience of a temperate of 80±5° C. and a relative humidity of 90±10% (for example, refer to Patent Document 8).

It is described that as a technology to reduce the moisture permeability of a protective film via surface treatment of the exposed surface of a cellulose-based resin, on a plastic resin substrate, a hard organic resin layer and an anti-reflection layer formed of a plurality of inorganic compounds having different refractive index are laminated in this sequential order to obtain an anti-reflection film, whereby the water vapor permeability rate of the anti-reflection film at a temperature of 60° C. and a relative humidity of 95% is allowed to be at most half of the water vapor permeability rate of the plastic resin substrate and further allowed to at most 500 g/m²/day (for example, refer to Patent Document 9). Further, it is described that on a transparent substrate film, a silicon oxide layer is formed by a CVD (Chemical Vapor Deposition) method, whereby an optically functional film exhibiting excellent moisture resistance is realized (for example, refer to Patent Document 10).

When such a protective film of small moisture permeability is arranged at least on one side of a polyvinyl alcohol-based polarizer, especially on its outermost surface, excellent durability is expressed under a humid and hot ambience, but during exposure under a high temperature ambience at a low humidity, such a problem has been produced that wrinkle-like defects occur on the surface, whereby appearance change occurs, which adversely affects the display of a liquid crystal display device.

Further, a trial is disclosed in which triphenyl phosphate as a so-called plasticizer is incorporated in a cellulose resin to improve moisture permeability and to enhance durability (for example, refer to Patent Document 11). When a large amount of such a plasticizer is used for a constituent resin, plasticization of a film itself is induced and also the plasticizer is gradually volatilized over an elapse of time, whereby a polarizing plate protective film is plasticized which has frequently caused heat resistance degradation and deformation, and due to volatilization of the plasticizer, durability degradation has been frequently increased with time.

In view of the above conventional technological problems, the present invention was achieved. An object of the present invention is to provide a polarizing plate having an appropriate moisture permeability to protect a polarizer from humidity even under a humid and hot ambience, as well as having durability and exhibiting excellent productivity; and a liquid crystal display in which excellent display quality is maintained by employing the polarizing plate.

### Prior Art Documents

### Patent Documents

Patent Document 1: Unexamined Japanese Patent Application Publication (hereinafter referred to as JP-A) No. 5-306344

Patent Document 2: JP-A No. 2002-12728

Patent Document 3: JP-A No. 2005-146084

Patent Document 4: JP-A No. 2007-191706

Patent Document 5: JP-A No. 59-159109

Patent Document 6: JP-A No. 60-159704

Patent Document 7: JP-A No. 7-77608

Patent Document 8: JP-A No. 2003-183417

Patent Document 9: JP-A No. 2004-53797

Patent Document 10: JP-A No. 2004-341541

Patent Document 11: JP-A No. 2007-102179

### BRIEF DESCRIPTION OF THE INVENTION

### Problems to be Solved by the Invention

An object of the present invention is to provide a polarizing plate used for liquid crystal display exhibiting excellent durability and a liquid crystal display device using this polarizing plate.

### Means to Solve the Problems

The above object of the present invention can be achieved by the following constitution:

1. A polarizing plate comprising an acrylic resin-containing film at least on one side thereof, wherein the acrylic resin-containing film contains an acrylic resin (A) and a cellulose ester resin (B) at a mass ratio of from 95:5 to 30:70 in a miscible state; a weight average molecular weight Mw of the acrylic resin (A) is not less than 80000; a total substitution degree (T) of acyl groups of the cellulose ester resin (B) is 2.00-3.00 and a substitution degree of acyl groups of a carbon number of 3-7 is 1.2-3.0; and a weight average molecular weight Mw of the cellulose ester resin (B) is not less than 75000.

2. The polarizing plate, described in item 1, wherein the acrylic resin-containing film contains acrylic fine particles at 0.5-45% by mass based on 100% of the total mass of the acrylic resin-containing film.

3. In the polarizing plate described in item 1 or 2, a polarizing plate wherein at least one sheet of the acrylic resin-containing film is arranged on the outside of a polarizer with respect to a display element.

4. A liquid crystal display device using the polarizing plate described in any one of items 1-3.

### Effects of the Invention

The present invention made it possible to provide a polarizing plate exhibiting excellence in polarizer degradation, as well as in scratch resistance and adhesion properties, and a liquid crystal display device.

### BRIEF DESCRIPTION OF THE DRAWINGS

FIG. 1 is a view schematically illustrating a dope preparation step, a casting step, and a drying step of a solution casting film production method used for the present invention.

### PREFERRED EMBODIMENT TO CARRY OUT THE INVENTION

The preferred embodiment to carry out the present invention will now be detailed that by no means limits the scope of the present invention.

Conventionally, as a polarizing plate protective film, a cellulose ester film is commonly used. However, such a cellulose ester film has exhibited the disadvantage of larger hygroscopicity than an acrylic film. However, when hygroscopicity is intended to be improved by mixing an acrylic resin with an cellulose ester resin, both of them tend not to be miscibilized with each other, leading to increased haze, whereby use as an optical film has been difficult. Especially, an acrylic resin of large molecular weight is considered to be immiscible with a cellulose ester film, whereby hygroscopicity improvement via resin mixing has been considered difficult. In JP-A No. 2003-12859, it is described that an acrylic resin of relatively small molecular weight is added as a plasticizer to a cellulose ester resin. However, the added amount thereof is small, whereby no hygroscopicity can be improved, and further due to addition of such an acrylic resin of small molecular weight, heat resistance is decreased, whereby suitable characteristics as a polarizing plate used for large-sized liquid crystal display devices or liquid crystal display devices for outdoor applications have been unable to be realized.

On the other hand, an acrylic resin film has the properties in which heat resistance is poor, whereby the form thereof tends to change in use at high temperatures and over long-term use, and poor brittleness is expressed. In Patent Documents 1-3, challenges are made to improve characteristics of an acrylic resin but adequate characteristics as an optical film have not been realized. In Patent Document 3, a technology to improve heat resistance was created by mixing a cellulose ester resin with an acrylic resin, but since a cellulose ester resin of large molecular weight has been considered not to be mixed with an acrylic resin, a cellulose ester resin of small molecular weight was added, resulting in inadequate improvement of brittleness.

However, as a result of investigations conducted by the present inventors, it was found that a cellulose ester resin having a specific substitution degree exhibited enhanced miscibility with an acrylic resin having a specific molecular weight, and surprisingly, it was found out that a cellulose ester resin of a relatively large molecular weight was also able to be allowed to be miscible with no haze increase.

As a result, it was fount that an acrylic resin (A) and a cellulose ester resin (B) were blended in the range of a specific mixing ratio, whereby each disadvantage of the acrylic resin and the cellulose ester resin was improved and thereby an acrylic resin-containing film exhibiting low hygroscopicity, being transparent, and exhibiting large weather resistance, as well as having remarkably improved brittleness was realized; and thus the present invention was completed.

Namely, according to a polarizing plate using an acrylic resin-containing film at least on one side thereof in which an acrylic resin (A) and a cellulose ester resin (B) are contained at a mass ratio of 95:5-30:70 in a miscible state; the weight average molecular weight Mw of the acrylic resin (A) is at least 80000; the total substitution degree (T) of acyl groups of the cellulose ester resin (B) is 2.00-3.00 and the substitution degree of acyl groups of a carbon number of 3-7 is 1.2-3.0; and the weight average molecular weight Mw of the cellulose ester resin (B) is at least 75000, a polarizing plate for liquid crystal display exhibiting excellent durability is realized.

Further, a preferable constitution is as follows: the acrylic resin-containing film contains acrylic fine particles at 0.5-45% by mass based on 100% of the total mass of the acrylic resin-containing film.

Especially, a polarizing plate, in which at least one sheet of the acrylic resin-containing film is arranged on the outside of a polarizer with respect to a display element, is applied at least to one side of a polarizing plate, whereby a liquid crystal display device with reduced viewing angle change and color shift can be realized. The present invention is an invention relating to a polarizing plate in which an acrylic resin-containing film to be described is used at least on one side thereof; and a liquid crystal display device in which the polarizing plate is used at least on one side of a liquid crystal cell.

<Acrylic Resin (A)>

Acrylic resins employed in the present invention include methacrylic resins. These resins are not particularly limited, and preferred resins include those which are composed of methyl methacrylate units of 50-99% by mass and other monomer units of 1-50% by mass which are copolymerizable with the above.

Other copolymerizable monomers include α,β-unsaturated acids such as alkyl methacrylate, in which a carbon number of the alkyl group is 2-18, alkyl acrylate, in which a carbon number of the alkyl group is 1-18, acrylic acid, or methacrylic acid; unsaturated groups containing divalent carboxylic acids such as maleic acid, fumaric acid, or itaconic acid; aromatic vinyl compounds such as styrene, α-methylstyrene or nuclear substituted styrene; and α,β-unsaturated nitriles such as acrylonitrile or methacrylonitrile; as well as maleic anhydride, maleimide, N-substituted maleimide, and glutaric anhydride. These may be employed individually or in combinations of at least two types.

Of these, in view of heat-decomposition resistance and fluidity of copolymers, preferred are methyl acrylate, ethyl acrylate, n-propyl acrylate, n-butyl acrylate, s-butyl acrylate, and 2-ethylhexyl acrylate, and methyl acrylate and n-butyl acrylate are particularly preferred to be employed.

In view of brittleness of an acrylic-resin-containing film and a transparency when mixing with a cellulose ester resin (B), the acrylic resin (A) employed in the acrylic-resin-containing film of the present invention has preferably the weight average molecular weight (Mw) of 80,000 or more. When the weight average molecular weight (Mw) of the acrylic resin (A) is less than 80,000, enough brittleness improvement cannot be obtained and further miscibility with cellulose ester resin (B) becomes poor. The weight average molecular weight (Mw) of the acrylic resin (A) is preferably in a range of 80,000-1,000,000, more preferably in a range of 100,000-600,000, the most preferably in a range of 150,000-400,000. The upper value of the weight average molecular weight (Mw) of the acrylic resin (A) is not particularly limited, but in view of a production process, preferred is 1,000,000 or less.

It is possible to determine the weight average molecular weight of acrylic resins of the present invention via gel permeation chromatography. Measurement conditions are as follows.

Solvent: methylene chloride
Columns: Shodex K806, K805, and K803G (produced by Showa Denko K. K., three columns were employed via connections)
Column temperature: 25° C.
Sample concentration: 0.1% by mass
Detector: RI Model 504 (produced by GL Sciences Inc.)
Pump: L6000 (produced by Hitachi Ltd.)
Flow rate: 1.0 ml/minute
Calibration curve: A calibration curve prepared by employing 13 samples of standard polystyrene STK (produced by Tosoh Corp. Mw=2,800,000−500) was employed. It is preferable to employ the 13 samples at nearly equal intervals.

The manufacturing methods of acrylic resin (A) in the present invention are not particularly limited, and employed may be any of the conventional methods such as suspension polymerization, emulsion polymerization, bulk polymerization, or solution polymerization. As a polymerization initiator, employed may be common peroxide based and azo based ones. Further, redox based ones may be included. As a polymerization temperature, employed may be at 30-100° C. in suspension polymerization or emulsion polymerization, and at 80-160° C. in bulk polymerization or solution polymerization. Further, in view of controlling a reduced viscosity of produced copolymer, a chain transfer agent such as alkyl mercaptan may be employed in polymerization.

As the acrylic resin according to the present invention, also employed may be commercial ones. Examples thereof include DERPET 60N and 80N (both produced by Asahi Kasei Chemicals Co., Ltd.), DIANAL BR52, BR80, BR83, BR85, and BR88 (all manufactured by Mitsubishi Rayon Co., Ltd.), and KT75 (produced by Denki Kagaku Kogyo K. K.).

<Cellulose Ester Resin (B)>

In the cellulose ester resin (B) of the present invention, especially from the viewpoint of brittleness improvement and transparency in cases when mixed with an acrylic resin (A), it is preferable that the total substitution degree (T) of acyl groups is 2.00-3.00; the substitution degree of acyl groups of a carbon number of 3-7 is 1.2-3.0; and the substitution degree of acyl groups of a carbon number of 3-7 is 2.0-3.0. Namely, the cellulose ester resin of the present invention is a cellulose ester resin substituted with acyl groups of a carbon number of 3-7, and specifically a propionyl group and a butyryl group are preferably used. Of these, a propionyl group is specifically preferably used.

When the total substitution degree of acyl groups of a cellulose ester resin (B) is less than 2.0, namely, when the residual degree of the hydroxyl groups at the 2, 3, and 6 positions of a cellulose ester molecule is more than 1.0, inadequate miscibility with an acrylic resin (A) is realized, resulting in a haze problem. Further, even when the total substitution degree of acyl groups is at least 2.0, in cases where the substitution degree of acyl groups of a carbon number of 3-7 is less than 1.2, also inadequate miscibility is realized or brittleness is deteriorated. For example, even in cases where the total substitution degree of acyl groups is at least 2.0, when the substitution degree of an acyl group of a carbon number of 2, namely, an acetyl group is high and the substitution degree of acyl groups of a carbon number of 3-7 is less than 1.2, miscibility is decreased, resulting in increased haze. Further, even in cases where the total substitution degree of acyl groups is at least 2.0, when the substitution degree of an acyl group of a carbon number of at least 8 is high and the substitution degree of acyl groups of a carbon number of 3-7 is less than 1.2, brittleness is deteriorated and thereby desired characteristics cannot be realized.

The acyl group substitution degree of the cellulose ester resin (B) of the present invention is non-problematic when the total substitution degree (T) is 2.0-3.0 and the substitution degree of acyl groups of a carbon number of 3-7 is 1.2-3.0. However, it is preferable that the total substitution degree of acyl groups of other than a carbon number of 3-7, namely, an acetyl group and acyl groups of a carbon number of at least 8 is at most 1.3.

In the present invention, the above acyl group may be an aliphatic acyl group or an aromatic acyl group. The aliphatic acyl group may be a straight-chain or branched one and further may have a substituent. The number of carbons of the acyl group of the present invention covers substituents of the acyl group.

When the cellulose ester resin (B) has an aromatic acyl group as a substituent, the number of substituents X substituting the aromatic ring is preferably 0-5. Also in this case, it is necessary to note that the substitution degree of acyl groups of a carbon number of 3-7 including substituents is allowed to be 1.2-3.0. For example, since the carbon number of a benzyl group is 7, when a substituent having carbon atoms is contained therein, the carbon number as the benzyl group becomes at least 8, which is excluded from the acyl group of a carbon number of 3-7.

Further, when the number of substituents substituting an aromatic ring is at least 2, these substituents may be the same or differ, and also may be bonded to each other to form a condensed polycyclic compound (for example, naphthalene, indene, indane, phenanthrene, quinoline, isoquinoline, chromene, chromane, phthalazine, acridine, indole, or indoline).

In the cellulose ester resin (B), a structure in which at least one type of aliphatic acyl group of a carbon number of 3-7 substituted or unsubstituted is contained is employed as the structure used for the cellulose resin of the present invention.

With regard to the substitution degree of the cellulose ester resin (B) of the present invention, the total substitution degree (T) of acyl groups is 2.0-3.0 and the substitution degree of acyl groups of a carbon number of 3-7 is 1.2-3.0.

Further, a preferable structure is as follows: the total substitution degree of other than acyl groups of a carbon number of 3-7, namely, an acetyl group and acyl groups of a carbon number of at least 8 is at most 1.3.

The cellulose ester resin (B) of the present invention is preferably at least one type specifically selected from cellulose acetate propionate, cellulose acetate butyrate, cellulose acetate benzoate, cellulose propionate, and cellulose butyrate. Namely, those having acyl groups of 3 or 4 carbon atoms as substituents are preferable.

Of these, a specifically preferable cellulose ester resin is cellulose acetate propionate or cellulose propionate.

Portions unsubstituted with acyl groups normally exist as hydroxyl groups. These can be synthesized via a well-known method.

Herein, the substitution degree of an acetyl group and the substitution degree of other acyl groups were determined via a method defined in ASTM-D817-96.

The weight average molecular weight (Mw) of the cellulose ester resin of the present invention is at least 75000 especially from the viewpoint of miscibility with an acrylic resin (A) and brittleness improvement, preferably in the range of 75000-300000, more preferably 100000-240000, specifically preferably 160000-240000. When the weight average molecular weight (Mw) of the cellulose ester resin is less than 75000, heat resistance and the improvement effect of brittleness are inadequately realized, whereby no effects of the present invention can be produced.

In the acrylic resin-containing film of the present invention, an acrylic resin (A) and a cellulose ester resin (B) are contained at a mass ratio of 95:5−30:70 in a miscible state, preferably 95:5−50:50, more preferably 90:10−60:40.

Compared to a mass ratio of 95:5 of the acrylic resin (A) and the cellulose ester resin (B), when the acrylic resin (A) exists at a larger ratio, the effect of the cellulose ester resin (B) is inadequately realized. When the acrylic resin exists at a smaller ration compared to 30:70, inadequate moisture resistance is realized.

In the acrylic resin-containing film of the present invention, an acrylic resin (A) and a cellulose ester resin (B) need to be contained in a miscible state. Physical properties and quality required for the acrylic resin-containing film are achieved through mutual complement by allowing different resins to be miscible.

It is possible to judge, for example, by glass transition temperature Tg whether or not the acrylic resin (A) and the cellulose ester resin (B) are in the miscible state.

For example, in cased where the glass transition temperatures of both resins differ, when the both resins are mixed, at least 2 glass transition temperatures exist for the resulting mixture due to the existence of the glass transition temperature of each resin. In contrast, when the both resins has been miscibilized, the inherent glass transition temperature of each resin disappears, resulting in one glass transition temperature, which becomes a characteristic in which the glass transition temperature of the miscibilized resin appears.

Incidentally, the glass transition temperature referred to herein is designated as a midpoint glass transition temperature (Tmg) determined at a temperature elevation rate of 20° C./minute based on JIS K7121 (1987) using a differential scanning calorimeter (Type DSC-7, produced by Perkin Elmer, Inc.).

The acrylic resin (A) and the cellulose ester resin (B) each are preferably noncrystalline resins. Either one may be a crystalline polymer or a partially crystalline polymer. However, in the present invention, the acrylic resin (A) and the cellulose ester resin (B) are preferably miscibilized to form into a noncrystalline resin.

In the acrylic resin-containing film of the present invention, the weight average molecular weight (Mw) of an acrylic resin (A) and the weight average molecular weight (Mw) and the substitution degree of a cellulose ester resin (B) are obtained in such a manner that using the solubility difference in a solvent of both resins, the both are separated and then determination for each resin is conducted. When these resins are separated, a miscibilized resin is added in a solvent dissolving only either one, whereby a dissolved resin can be extracted and separated. In this case, a heating operation or refluxing may be carried out. Such solvent combination may be combined for at least 2 steps for resin separation. A dissolved resin and a resin remaining as an insoluble substance are filtered, and then with regard to the solution containing the extract, the resin can be separated by an operation to evaporate the solvent, followed by drying. These separated resins can be identified via common structure analysis of a polymer. Also in cases where the acrylic resin-containing film of the present invention contains resins other than the acrylic resin (A) and the cellulose ester resin (B), such separation can be carried out using the same method.

Further, when the weight average molecular weights (Mw's) of miscibilized resins are different from each other, using gel permeation chromatography (GPC), separation can easily be carried out and also molecular weight determination can be conducted, since a high molecular weight substance is eluted at an early point and then a lower molecular weight substance is eluted over a longer period of time.

Still further, the molecular weight of a miscibilized resin is determined by GPC and at the same time, resin solutions having been eluted each for a certain period of time are fractionated and resins are obtained by distilling off the solvent, followed by drying, and then structural analysis of the resins is quantitatively conducted, whereby the resin compositions of different molecular weights for each fraction are detected and thereby the miscibilized resins each can be identified. Further, the molecular weight distribution of each resin having been previously fractionated based on the solubility difference with respect to the solvent is determined using GPC, whereby each miscibilized resin can also be detected.

In the present invention, an acrylic resin (A) and a cellulose ester resin (B) need to be miscibilized via mixing thereof in the scope of the present invention.

For example, in a step in which a precursor of an acrylic resin such as a monomer, dimer, or oligomer is mixed with a cellulose ester resin (B), followed by polymerization to obtain a mixed resin, polymerization reaction is complicated. Therefore, with regard to a resin produced by such a method, reaction control is difficult. Further, when a resin is synthesized by such a method, graft polymerization, cross linking reaction, or cyclization reaction frequently occurs, whereby dissolution into a solvent or melting by heating cannot be carried out in many cases, and then use as a resin to stably produce an acrylic resin-containing film is difficult. Therefore, no resin obtained by such a method falls into a resin in which the acrylic resin (A) and the cellulose ester resin (B) of the present invention are contained in a miscible state.

The acrylic resin-containing film of the present invention may be constituted by incorporating resins other than an acrylic resin (A) and a cellulose ester resin (B) and additives, unless the function as the acrylic resin-containing film of the present invention is impaired.

When resins other than the acrylic resin (A) and the cellulose ester rein (B) are contained, resins to be added may be in a miscible state or mixed without being dissolved.

In the acrylic resin-containing film of the present invention, the total mass of the acrylic resin (A) and the cellulose ester resin (B) is preferably at least 55% by mass of the acrylic resin-containing film, more preferably at least 60% by mass, specifically preferably at least 70% by mass.

When resins other the acrylic resin (A) and the cellulose ester rein (B) and additives are used, the added amounts thereof are preferably adjusted in a range in which the function of the acrylic resin-containing film of the present invention is not impaired.

<Acrylic Particles>

According to the present invention, acrylic particles may be included in the acrylic-resin-containing film.

Acrylic particles according to the present invention preferably exist in a particle state (hereinafter also referred to as an immiscible state) in an acrylic-resin-containing film incorporating above acrylic resin and cellulose ester resin.

For example, when predetermined amount of prepared acrylic-resin-containing film was sampled and dissolved by stirring in solvent to fully solved and dispersed, followed by filtering by using membrane filter made of PTFE having pore size less than average particle diameter of Acrylic particles, it is preferable that a weight of an insoluble matter captured by filtering is 90% by mass or more of an amount of the Acrylic particles added in to the acrylic-resin-containing film.

Acrylic particles of the present invention is not limited thereto, but it is preferable to be Acrylic particles having 2 or more layer structure, especially acrylic particle complex having multi-layer structure described below.

“Multilayer structure acrylic granular complex”, as described herein, refers to a granular acrylic polymer having a multilayer structure in which an innermost hard layer polymer, a cross-linked soft layer polymer having rubber elasticity and an outermost soft layer polymer are stacked in layers toward the periphery from the center.

As a preferred embodiment of the multilayer structure acrylic granular complex employed in the acrylic resin composition according to the present invention, listed is the one described below: an acrylic granular complex which incorporates a 3-layer structure composed of (a) an innermost hard layer polymer which is prepared by polymerizing a monomer mixture of 80-98.9% by mass of methyl methacrylate, 1-20% by mass of alkyl acrylate in which a carbon number of the alkyl group is 1-8, and 0.01-0.3% by mass of polyfunctional grafting agents, (b) a crosslinked soft layer polymer which is prepared by polymerizing, in the presence of the above innermost hard layer polymer, a monomer mixture of 75-98.5% by mass of alkyl acrylate in which a carbon number of the alkyl group 4-8, 0.01-5% by mass of polyfunctional cross linking argents, and 0.5-5% by mass of functional grafting agents, and (c) an outermost hard layer polymer which is prepared by polymerizing, in the presence of the polymer composed of the above innermost hard layer and crosslinked soft layer, a monomer mixture of 80-99% by mass of methyl methacrylate, 1-20% by mass of alkyl acrylate in which a carbon number of the alkyl group of 1-8, and the resulting 3-layer structure polymer is composed of 5-40% by mass of innermost hard layer polymer (a), 30-60% by mass of soft layer polymer (b), and 20-50% by mass of outermost hard layer polymer (c), and when being subjected to fraction via acetone, an insoluble portion exists and the methyl ethyl ketone swelling degree of the above insoluble portion is 1.5-4.0.

As disclosed in Japanese Patent Publications No. 60-17406 and 3-39095, not only by specifying the composition of each layer of the multilayer structure acrylic granular complex and the particle size, but also by setting the pulling elastic modulus of the multilayer structure acrylic granular complex and the methyl ethyl ketone swelling degree of the acetone-insoluble portion within the specified range, it is possible to realize a sufficient balance between the impact resistance and the stress resistance whitening properties.

It is preferable that innermost hard layer polymer (a), which constitutes the multilayer structure acrylic granular complex, is prepared by polymerizing a monomer mixture composed of 80-98.9% by mass of methyl methacrylate, 1-20% by mass of alkyl acrylate in which a carbon number of the alkyl group is 1-8, and 0.01-0.3% by mass of polyfunctional grafting agents.

Alkyl acrylates, in which a carbon number of the alkyl group is 1-8, include methyl acrylate, ethyl acrylate, n-propyl acrylate, n-butyl acrylate, s-butyl acrylate, and 2-ethylhexyl acrylate, and of these, preferably employed are methyl acrylate and n-butyl acrylate.

The ratio of alkyl acrylate units in innermost hard layer polymer (a) is 1-20% by mass. When this ratio is less than 1% by mass, polymer tends to be thermally decomposed. On the contrary, in case of this ratio being more than 20% by mass, a glass transition temperature of an innermost hard layer polymer (c) becomes lower, resulting in decreasing an effect of impact resistance of an acrylic granular complex having a 3-layer structure, and both are undesirable.

Polyfunctional grafting agents include polyfunctional monomers, having different polymerizable functional groups, such as allyl ester with acrylic acid, methacrylic acid, maleic acid, and fumaric acid, and allyl methacrylates are preferably employed. Polyfunctional grafting agents are employed to chemically combine the innermost hard layer polymer and the soft layer polymer. The ratio when employed in the innermost hard layer polymerization is 0.01-0.3% by mass.

As crosslinked soft layer polymer (b) which constitutes an acrylic granular complex, preferred is one which is prepared by polymerizing, in the presence of above innermost hard layer polymer (a), a monomer mixture of 75-98.5% by mass of alkyl acrylate in which a carbon number of the alkyl group is 1-8, 0.01-5% by mass of polyfunctional cross linking agents, and 0.5-5% by mass of polyfunctional grafting agents.

As an alkyl acrylate in which a carbon number of the alkyl group is 4-8, preferably employed are n-butyl acrylate and 2-ethylhexyl acrylate.

Further, together with these polymerizable monomers, it is possible to copolymerize other monofunctional monomers at 25% by mass or less which are copolymerizable.

Other monofunctional monomers which are copolymerizable include styrene and substituted styrene derivatives. With regard to the ratio of alkyl acrylates in which a carbon number of the alkyl group is 4-8 to styrene, as the former ratio increases, the glass transition temperature of polymer (b) is lowered, whereby softness is achievable.

On the other hand, in view of transparency of resin compositions, it is advantageous to approach the refractive index of soft layer polymer (b) at normal temperature to that of innermost hard layer polymer (a), outermost hard layer polymer (c), and thermally plastic hard acrylic resins. Upon considering the above, the ratio of both is chosen.

For example, in case of usage for thinner thickness of covered layer, styrene is not necessary to be copolymerized.

As a polyfunctional grafting agent, employed may be ones cited in the item of above innermost layer hard polymer (a). Polyfunctional grafting agents employed herein are employed to chemically combine soft layer polymer (b) and outermost hard layer polymer (c), and in view of providing of targeted impact resistance effects, the ratio employed during the innermost hard layer polymerization is preferably 0.5-5% by mass.

As an employable polyfunctional cross linking agent may be commonly known cross linking agents such as divinyl compounds, diallyl compounds, or dimethacryl compounds. Of these, preferably employed are polyethylene glycol diacrylates (at a molecular weight of 200-600).

Polyfunctional cross linking agents, employed herein, are employed to realize effects of impact resistance via formation of a cross linking structure during polymerization of soft layer (b). However, when the above polyfunctional grafting agents are employed during polymerization of the soft layer, the cross linking structure in soft layer (b) is formed to some extent. Accordingly, polyfunctional cross linking agents are not essential components. In view of targeted effects to provide impact resistance, the ratio of polyfunctional cross linking agents during soft layer polymerization is preferably 0.01-5% by mass.

As outermost hard layer polymer (c) which constitutes a multilayer structure acrylic granular complex, preferred is one which is prepared, in the presence of the above innermost hard layer polymer (a) and soft layer polymer (b), by polymerizing a monomer mixture composed of 80-99% by mass of methyl methacrylate and 1-20% by mass of alkyl acrylate in which a carbon number in the alkyl group is 1-8.

As alkyl acrylates, employed are those described above, and of these, preferably employed are methyl acrylate and ethyl acrylate. The ratio of alkyl acrylate units in uppermost hard layer (c) is preferably 1-20% by mass.

Further, to enhance miscibility with acrylic resin (A) during polymerization of outermost hard layer (c), it is possible to employ mercaptan as a chain transfer agent to regulate the resulting molecular weight.

In particular, to improve the balance between elongation and impact resistance, it is preferable to result in a gradient so that the molecular weight gradually decreases from the interior to the exterior. A specific method is as follows. A monomer mixture to form the outermost hard layer is divided into at least two parts. By a technique in which chain transfer agents, which are added each time, are gradually increased, it is possible to decrease the molecular weight of polymers to form the outermost hard layer from the interior of the multilayer structure acrylic granular complex to the exterior.

It is possible to check the molecular weight during the above formation as follows. The monomer mixture employed each time is individually polymerized under the same conditions, and the molecular weight of the resulting polymer is determined.

The diameter of acrylic granular complex preferably employed in multilayer structure polymer of the present invention is not particularly limited. The above diameter is preferably 10-1,000 nm, is more preferably 20-500 nm, but is most preferably 50-400 nm.

In the acrylic granular complex, which is the multilayer structure polymer preferably employed in the present invention, the weight ratio of the core and the shell is not particularly limited. When the entire multilayer structure polymer is assigned at 100 parts by mass, the core layer occupies preferably 50-90 parts by mass, but occupies more preferably 60-80 parts by mass.

Examples of commercial products of the above multilayer structure acrylic granular complex include “METABLEN” produced by Mitsubishi Rayon Co., Ltd., “KANEACE” produced by Kaneka Corp., “PARALOID” produced by Kureha Chemical Industry Co., Ltd., “ACRYLOID” produced by Rohm and Haas Co., “STAFILOID” produced by Ganz Chemical Industry Co., and “PARAPET SA” produced by Kuraray Co., Ltd. These products may be employed individually or in combinations of at least two.

Further, specific examples of acrylic particles, which are composed of graft copolymers, appropriately employed as acrylic particles preferably employed in the present invention, include graft polymers which are prepared by copolymerizing, in the presence of rubber polymers, a mixture of monomers composed of unsaturated carboxylic acid ester based monomers, unsaturated carboxylic acid based monomers, and aromatic vinyl based monomers, as well as if desired, other vinyl based monomers which are copolymerizable with the above.

Rubber polymers employed in acrylic particles, which are graft copolymers, are not particularly limited, and diene based rubber, acryl based rubber, and ethylene based rubber are employable. Specific examples thereof include polybutadiene, styrene-butadiene copolymers, styrene-butadiene block copolymers, acrylonitrile-butadiene copolymers, butyl acrylate-butadiene copolymers, polyisoprene, butadiene-methyl methacrylate copolymers, butyl acrylate-methyl methacrylate copolymers, butadiene-ethyl acrylate copolymers, ethylene-propylene copolymers, ethylene-propylene-diene based copolymers, ethylene-isoprene copolymers, and ethylene-methyl acrylate copolymers. These rubber polymers may be employed individually or in combinations of at least two types.

Further, in view of preparation of a highly transparent acrylic-resin-containing film of the present invention, it is preferable that the refractive index of acrylic resin is near that of acrylic particles. Specifically, any difference in the refractive index between acrylic particles and acrylic resin is preferably at most 0.05, is more preferably at most 0.02, but is most preferably at most 0.01.

In order to satisfy the above refractive index conditions, it is possible to decrease the difference in refractive index by employing a method in which each monomer unit composition ratio is regulated, and/or a method in which the composition ratio of employed rubber polymers or monomers is regulated, whereby it is possible to prepare an acrylic-resin-containing film which excels in transparency.

“Difference in refractive index”, as described herein, refers to the following. The acrylic-resin-containing film of the present invention is sufficiently dissolved in acrylic resin dissolvable solvents under optimal conditions to prepare a milky-white solution. The resulting solution is separated into a solvent soluble portion and a solvent insoluble portion via an operation such as centrifugal separation. Subsequently, each of the soluble portion (acrylic resin) and the insoluble portion (acrylic particles) is purified. Thereafter, each refractive index is determined (at 23° C. and 550 nm wavelength), whereby the difference is obtained.

Methods to blend acrylic resin with acrylic particles in the present invention are not particularly limited. A method is preferably employed in which after blending acrylic resin with other optional components, the resulting blend is homogeneously melt-kneaded via a uniaxial or biaxial extruder while adding acrylic particles.

Further, it is possible to employ a method in which a solution, into which acrylic particles have been dispersed, is mixed with a solution (being a dope solution) which is prepared by dissolving acrylic resin and cellulose ester resin in solvents, and a method in which a solution which is prepared by dissolving acrylic particles and other optional additives in solvents is added in-line.

It is possible to employ, as the acrylic particles according to the present invention, commercial products. Examples thereof may include METABLEN W-341 (C2) (produced by Mitsubishi Rayon Co., Ltd.) and CHEMISNOW MR-2G (C3) and MS-300X (C4) (produced by Soken Chemical & Engineering Co., Ltd.).

The acrylic-resin-containing film of the present invention incorporates acrylic particles, preferably in the amount range of 0.5-45% by mass with respect to the total mass of resins constituting the above film.

<Other Additives>

In the acrylic-resin-containing film of the present invention, in order to enhance fluidity and flexibility of the composition, it is possible to simultaneously employ plasticizers. Plasticizers may be phthalic acid based, aliphatic acid ester based, trimellitic acid ester based, phosphoric acid ester base, polyester based, or epoxy based.

Of these, polyester based and phthalic acid based plasticizers are preferably employed. The polyester based plasticizers excel in non-mobility and extraction resistance, compared to phthalic acid ester based plasticizers such as dioctyl phthalate, but are slightly inferior in plasticizing effects and miscibility.

Consequently, by selecting or simultaneously employing these plasticizers depending on intended use, they may fill a wide range of applications.

Polyester based plasticizers are reactants of uni- to tetravalent carboxylic acid with uni- to hexahydric alcohol, and those, which are prepared by allowing divalent carboxylic acid to react with glycol, are mainly employed. Representative divalent carboxylic acids include glutaric acid, itaconic acid, adipic acid, phthalic acid, azelaic acid, and sebacic acid.

Particularly, the use of adipic acid and phthalic acid enables preparation of those which excel in plasticizing characteristics. Glycols include glycol of ethylene, propylene, 1,3-butylene, 1,4-butylene, 1,6-hexamethylene, neopentylene, diethylene, triethylene and dipropylene. These divalent carboxylic acids and glycols may be employed individually or in combinations.

The above ester based plasticizers may be any of the ester, oligoester or polyester type. The molecular weight is preferably in the range of 100-10,000, but is more preferably in the range of 600-3,000, at which range plasticizing effects are more enhanced.

Further, viscosity of plasticizers correlates with their molecular structure and weight. In the case of adipic acid based plasticizers, the viscosity is preferably in the range of 200-5,000 mPa·s (at 25° C.) from the relation with plasticization efficiency. Further, several polyester based plasticizers may be simultaneously employed.

It is preferable that 0.5-30 parts by mass of plasticizers are added to 100 parts by mass of the composition containing the acrylic resin. However, it is not preferable that in practice, the added amount of the plasticizers exceeds 30 parts by mass, since the surface becomes sticky.

It is preferable that the composition containing the acrylic resin of the present invention incorporates UV absorbers. Employed UV absorbers include those which are benzotriazole based, 2-hydoxybenzophenone based, and salicylic acid phenyl ester based. For example, cited may be triazoles such as 2-(5-methyl-2-hydroxyphenyl)benzotriazole, 2-[2-hydroxy-3,5-bis(α,α-dimethylbenzyl)phenyl]-2H-benzotriazole, or 2-(3,5-di-t-butyl-2-hydroxyphenyl)benzotriazole, as well as benzophenones such as 2-hydroxy-4-methoxybenzophenone, 2-hydroxy-4-octoxybenzophenone, or 2,2′-dihydroxy-4-methoxybenzophenone.

Of UV absorbers, those having a molecular weight of at least 400 exhibit a high boiling point and are neither easily volatized nor scattered during molding at high temperature. Consequently, it is possible to effectively improve weather resistance via their addition of a relatively small amount.

Further, it is preferred in view that a content of included UV absorbers can be maintained in long term and an effect of improvement for weather resistance continues excellently due to low transitivity especially from thin covered layer to substrate layer and low tendency to precipitation to a surface of laminated sheet.

UV absorbers having a molecular weight of at least 400 include benzotriazole based ones such as 2-[2-hydoxy-3,5-bis(α,α-dimethylbenzyl)phenyl]-2-benzoiriazole, or 2,2-methylenebis[4-(1,1,3,3-tetrabutyl)-6-(2H-benzotriazole-2-yl)phenol; hindered amine based ones such as bis(2,2,6,6tetramethyl-4-piperidyl)sebacate or bis(1,2,2,6,6-pentamethyl-4-piperidyl)sebacate; further hybrid based ones having hindered phenol and hindered amine structures in the molecule such as 2-(3,5-di-t-butyl-4-hydroxybenzyl)-2-n-butylmalonic acid bis(1,2,2,6,6-pentamethyl-4-piperidyl) or 1-[2-[3,5-di-t-butyl-4-hydroxyphenyl)propionyloxy]2,2,6,6-tetramethylpyperidine. These may be employed individually or in combinations of at least two types. Of these, particularly preferred are 2-[2-hydroxy-3,5-bis(α,α-dimethylbenzyl)phenyl]-2-benzotriazole and 2,2-methylenebis[4-(1,1,3,3-tetrabutyl)-6-(2H-benzotriazole-2-yl)phenol.

Further, in order to minimize thermal decomposition and thermal staining during molding, it is possible to add various antioxidants to acrylic resin used in the acrylic-resin-containing film of the present invention. Still thither, by the addition of antistatic agents, it is possible to provide the acrylic-resin-containing film with antistatic capability.

In the acrylic resin composition of the present invention, fire resistant acrylic resin compositions blended with phosphor based fire retardants may be employed.

As phosphor based fire retardants employed here, listed may be mixtures incorporating at least one selected from red phosphorous, triaryl phosphoric acid esters, diaryl phosphoric acid esters, monoaryl phosphoric acid esters, aryl phosphoric acid compounds, aryl phosphine oxide compounds, condensed aryl phosphoric acid esters, halogenated alkyl phosphoric acid esters, halogen-containing condensed phosphoric acid esters, halogen-containing condensed phosphoric acid esters, and halogen containing phosphorous acid esters.

Specific examples thereof include triphenyl phosphate, 9,10-dihydro-9-oxa-10-phosphaphenantholene-10-oxide, phenylphosphonic acid, tris(β-chloroethyl)phosphate, tris(dichloropropyl)phosphate, and tris(tribromoneopentyl)phosphate.

An acrylic resin-containing film used for the polarizing plate of the present invention makes it possible to simultaneously realize low hygroscopicity, transparency, enhanced heat resistance, and low brittleness which have been not realized with any conventional resin film, whereby a polarizing plate for liquid crystal display exhibiting excellent durability and a liquid crystal display device using this polarizing plate can be provided.

In the present invention, for the indicator of brittleness, judgment is made based on the standard weather “to be an acrylic resin-containing film free from ductile fracture occurrence.” When an acrylic resin-containing film with low brittleness in which no ductile fracture occurs is produced, even in cases where a polarizing plate used for a large-sized liquid crystal display device is produced, no fracture or cracking during production occurs, resulting in an acrylic resin-containing film exhibiting excellent handling properties. Herein, ductile fracture refers to fracture which occurs via the action of a larger stress than the strength possessed by a certain material, being defined as breaking involving marked elongation or squeezing of the material until the final fracture. This fracture surface is characterized by formation of an indefinitely large number of depressions referred to as dimples.

In the present invention, weather “to be an acrylic resin-containing film free from ductile fracture occurrence” is evaluated based on the fact that even when a large stress of the extent that the film is bent in two is applied, no breaking such as fracture occurs. Also when an acrylic resin-containing film free from ductile fracture occurrence even with such a generated large stress is used as a polarizing plate protective film for a large-sized liquid crystal display device, the problem of fracture during production can substantially be reduced. Further, also in cases where such an acrylic resin-containing film is used via re-peeling after having been once bonded, no fracture occurs, which means that responding to realization of a thinner acrylic resin-containing film can also sufficiently be made.

In the present invention, as the indicator of heat resistance, tension softening point is employed. The size of liquid crystal display devices is increased and the luminance of backlight sources is more and more increased, and additionally, more enhanced luminance has been demanded due to use for outdoor applications such as digital signage, whereby an acrylic resin-containing film is required to withstand use under a higher temperature ambience. When the tension softening point thereof is 105° C.-145° C., it can be judged that adequate heat resistance is expressed. Especially, controlling in the range of 110° C.-130° C. is more preferable.

With regard to a specific determination method of the tension softening point of an acrylic resin-containing film, for example, using a TENSILON test instrument (RTC-1225A, produced by Orientec Co., Ltd.), an acrylic resin-containing film is cut out at a size of 120 mm (height)×10 mm (width) and then with pulling at a tension of 10 N, temperature elevation is continued at a temperature elevation rate of 30° C./min. Thereafter, the temperature at the moment when the tension reaches 9N is measured 3 times and determination is made by the average value.

Further, from the viewpoint of heat resistance, an acrylic resin-containing film preferably has a glass transition temperature (Tg) of at least 110° C., more preferably at least 120° C., specifically preferably at least 150° C.

Incidentally, the glass transition temperature referred to herein refers to a midpoint glass transition temperature (Tmg) determined via measurement at a temperature elevation rate of 20° C./minute based on JIS K7121 (1987) using a differential scanning calorimeter (Type DSC-7, produced by Perkin Elmer, Inc.).

As the indicator by which the transparency of the acrylic resin-containing film of the present invention is judged, haze value (turbidity) is employed. Especially in liquid crystal display devices used outdoors, even in bright places, adequate luminance and high contrast need to be realized. Therefore, the haze value needs to be at most 1.0%, more preferably at most 0.5%.

With the acrylic resin-containing film of the present invention, enhanced transparency can be realized. In a case when acrylic fine particles are used to improve another physical property, the refractive index difference between an acrylic resin (A) and an acrylic particle (C) is allowed to be minimized, whereby an increase in the haze value can be prevented.

Further, surface roughness also affects the haze value as surface haze. Therefore, it is effective to control the particle size or the added amount of the acrylic particle (C) in the above range and to reduce the surface roughness of a film contact portion during film production.

Still further, the hygroscopicity of the acrylic resin-containing film of the present invention is evaluated via dimensional changes resulting from humidity changes.

As an evaluation method of such dimensional changes according to humidity changes, the following method is employed.

In the casting direction of a produced acrylic resin-containing film, a mark (cross) is indicated at 2 locations, followed by 1000-hour treatment at 60° C. and 90% RH, and then the distance of the marks (crosses) prior to and after the treatment are measured using an optical microscope to determine dimensional change rate (%). The dimensional change rate (%) is represented by the following expression:

Dimensional change rate (%)=[(a1-a2)/a1]×100

a1: distance prior to heat treatment

a2: distance after heat treatment

The acrylic resin-containing film of the present invention having a dimensional change rate (%) of less than 0.5% can be evaluated as an acrylic resin-containing film exhibiting adequately low hygroscopicity, and the rate is more preferably less than 0.3%.

Further, in the acrylic resin-containing film of the present invention, defects having a diameter of at least 5 μm in-plane with the film exist preferably at a ratio of 1 defect/10 cm square or less, more preferably 0.5 defect/10 cm square or less, still more preferably 0.1 defect/10 cm square.

Herein, the diameter of such a defect represents the diameter when the defect is circular, and in the case of no circle, the range of the defect is determined via observation using a microscope by the following method and then its maximum diameter (the diameter of a circumscribed circle) is designated.

When such a defect is an air bubble or foreign material, the range of the defect is designated as the size of a shadow when the defect is observed by transmitted light of a differential interference microscope. When the defect is a change in the surface shape such as roll scratch transfer or abrasion, the defect is observed using reflective light of the differential interference microscope to confirm its size.

Herein, in the case of observation using reflective light, when the size of a defect is unclear, the surface thereof is deposited with aluminum or platinum for observation.

To obtain, with high productivity, a film exhibiting excellent quality represented by the above defect frequency, it is effective to carry out high precision filtration of a polymer solution immediately prior to casting, to increase the clean degree of the casting machine periphery, and to carry out effective drying with prevention of foam formation by gradually setting drying conditions after casting.

When the number of defects is more than 1 defect/10 cm square, for example, with a tension applied to a film during processing in a post-step, the film tends to be fractured from the defects as base points, whereby productivity is decreased in some cases. Further, when the diameter of the defect becomes at least 5 μm, visual confirmation can be made via polarizing plate observation, resulting, in some cases, in generation of luminescent spots in use as an optical member.

Further, even in cases where no visual confirmation can be carried out, when a hard coat layer is formed on the film, in some cases, a coating agent cannot be formed uniformly, resulting in a defect (coating loss). Herein, the defect refers to a void (foam defect) in a film generated due to rapid evaporation of a solvent in the drying step of solution film production, or a foreign material (foreign material defect) in a film resulting from foreign materials in a concentrated solution for film production or foreign materials mixed in during film production.

Still further, in the acrylic resin-containing film of the present invention, the fracture elongation of at least one direction thereof is preferably at least 10%, more preferably at least 20% in determination based on JIS-K7127-1999.

The upper limit of the fracture elongation is not specifically limited, being, however, practically about 250%. To increase the fracture elongation, it is effective to inhibit defects in the film resulting from foreign materials or foam formation.

The thickness of the acrylic resin-containing film of the present invention is preferably at least 20 μm, more preferably at least 30 μm.

The upper limit of the thickness is not specifically limited. However, in cases where the film is formed using a solution film production method, the upper limit is about 250 μm from the viewpoint of coatability, foam formation, and solvent drying. Herein, the thickness of the film can appropriately be selected depending on the intended application.

The total light beam transmittance of the acrylic resin-containing film of the present invention is preferably at least 90%, more preferably at least 93%. Further, a practical upper limit is about 99%. To realize excellent transparency as represented by the above total light beam transmittance, it is effective that no additives or copolymerization components absorbing the visible light are introduced; foreign materials in a polymer are eliminated via high precision filtration; and the diffusion or absorption of light within the film is reduced.

Further, it is effective that the surface roughness of film contact portions (cooling rolls, calender rolls, drums, belts, coating base materials in solution film production, and conveyance rolls) during film production is allowed to decrease to reduce the surface roughness of the film surface, and the refractive index of an acrylic resin is allowed to decrease to reduce the diffusion or reflection of light on the film surface.

The acrylic resin-containing film of the present invention preferably satisfies the above physical properties and thereby can specifically preferably be used as a polarizing plate for large-sized liquid crystal display devices or liquid crystal display devices for outdoor applications.

Such physical properties can be realized via an acrylic resin-containing film in which in the acrylic resin-containing film, an acrylic resin (A) and a cellulose ester resin (B) are contained at a mass ratio of 95:5-30:70; the weight average molecular weight (Mw) of the acrylic resin (A) is at least 80000; the total substitution degree (T) of acyl groups of the cellulose ester resin (B) is 2.00-3.00 and the substitution degree of acyl groups of a carbon number of 3-7 is 1.2-3.0; and the weight average molecular weight (Mw) of the cellulose ester resin is at least 75000.

<Film Production of Acrylic Resin-Containing Film >

Examples of the production method of an acrylic-resin-containing film will now be described, however the present invention is not limited thereto.

As an acrylic-resin-containing film production method of the present invention, employed may be an inflation method, a T-die method, a calendering method, a cutting method, a casting method, an emulsion method, or a hot press method. In view of coloration retardation, reduction of foreign matter defects, and decrease in optical defects of the die line, preferred is solution film production employing a casting method.

(Organic Solvents)

When the acrylic-resin-containing film of the present invention is produced via the solution casting method, as useful organic solvents to form a dope, any solvent may be employed without limitation as long as it simultaneously dissolves acrylic resin, cellulose ester resin and other additives.

Examples thereof may include, as chlorine based organic solvents, methylene chloride, and as non-chlorine based organic solvents, methyl acetate, ethyl acetate, amyl acetate, acetone, tetrahydrofuran, 1,3-dioxolane, 1,4-dioxane, cyclohexanone, ethyl formate, 2,2,2-trifluoroethanol, 2,2,3,3-hexafluoro-1-propanol, 1,3-difluoro-2-propanol, 1,1,1,3,3,-hexafluoro-2-methyl-2-propanol, 1,1,1,3,3,3-hexafluoro-2-propanol, 2,2,3,3,3-pentafluoro-1-propanol, and nitroethane. The methylene chloride, methyl acetate, ethyl acetate, and acetone are preferably employable.

It is preferable that other than the above organic solvents, incorporated in the dope, are aliphatic alcohols having a straight or branched chain having 1-4 carbon atoms in an amount of 1-40% by mass. As the alcohol ratio in the dope increases, the resulting web is gelled, whereby peeling from a metal support become easier. Further, as the ratio of alcohol is low, it enhances dissolution of acrylic resin and cellulose ester resin in non-chlorine based organic solvents.

Specifically, a dope composition is preferred which is prepared by dissolving, in solvents incorporating methylene chloride and aliphatic alcohols having a straight or branched chain having 1-4 carbon number, three of acrylic resin, cellulose ester resin, and acrylic fine particles in an total amount of 15-30% by mass.

As aliphatic alcohols having a straight or branched chain having 1-4 carbon atoms, listed may be methanol, ethanol, n-propanol, iso-propanol, n-butanol, sec-butanol, and tert-butanol. Of these, in view of exhibiting stability of dope, good drying due to low boiling point, ethanol is preffered.

The preferable film production method of the acrylic-resin-containing film of the present invention will now be described.

1) Dissolution Process

A dissolution process prepares a dope in such a manner that acrylic resin and cellulose ester resin and in some cases acrylic particles and other additives are dissolved, while stirring, in organic solvents mainly composed of good solvents for above acrylic resin and cellulose ester resin employing a dissolution kettle, or prepares a dope which is a major dissolution liquid by blending, in some cases, acrylic particles and other additive solutions with above acrylic resin and cellulose ester resin solution.

It is possible to dissolve acrylic resin and cellulose ester resin via various dissolution methods such as: a method in which dissolution is carried out at normal pressure, a method in which dissolution is carried out at the temperature of at most the boiling point of the major solvent, a method employing any of the cooling dissolution methods described in JP-A Nos. 9-95544, 9-95557, and 9-95538, a method, described in JP-A No. 11-21379, in which dissolution is carried out under high pressure. Of these, preferred is the method in which dissolution is carried out at the temperature of at least the boiling point of the major solvent under pressure application.

The total concentration of three components such as acrylic resin and cellulose ester resin in a dope is preferably in the range of 15-45% by mass. Additives are added to the dope during or after dissolution. After dissolution or dispersion, the resulting mixture is filtered via a filter and defoamed, followed by transfer to the next process via a solution conveying pump.

It is preferable that filtration is carried out employing a filter at a particle catching diameter of 0.5-5 μm and a filtered water time of 10-25 seconds/100 ml.

In the above method, aggregates remained during particle dispersion and formed during the addition of the major dope, are only removable by employing a filter at a particle catching diameter of 0.5-5 μm and a filtered water time of 10-25 seconds/100 ml. In a main dope, due to thoroughly thin concentration of particles comparing to in an adding solution, rapid increase in filter pressure by aggregating of aggregates does not occur in filtering process.

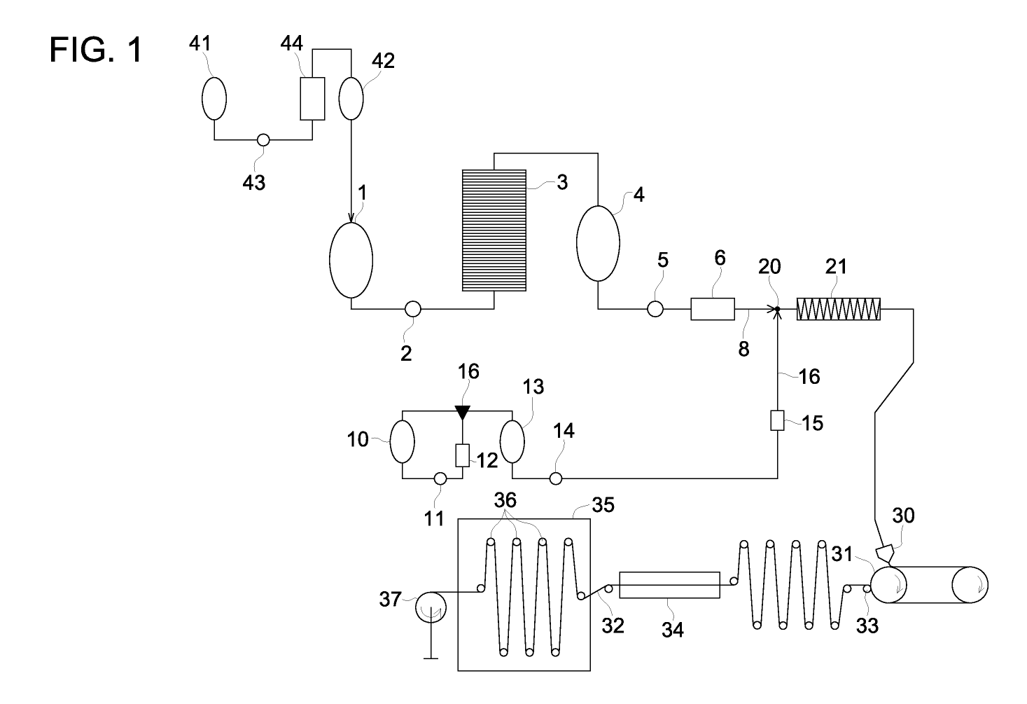

FIG. 1 is a schematic view of one example of a dope preparation process, a casting process, and a drying process of the solution casting film producing method which is preferred in the present invention.

If needed, large aggregates are removed via filtering device 44 from the acrylic particle preparation kettle 41, followed by transfer to stock kettle 42. Thereafter, an acrylic particle adding solution is added to major dope dissolving kettle 1 from stock kettle 42.

Thereafter, the major dope solution is filtered via major filtering device 3, followed by the inline addition of UV absorbing agent adding solution 16.

In many cases, the major dope occasionally incorporates side materials in an amount of about 10—about 50% by mass. Occasionally, the side materials include acrylic particles. In such a case, it is preferable to control the added amount of the acrylic particle adding solution matching to that of the added amount of the side materials.

The acrylic particle adding solution preferably contains acrylic particles of 0.5-10% by mass, more preferably 1-10% bay mass and most preferably 1-5% by mass.

Lower content of the acrylic particles results in easy handling due to lower viscosity and higher content of the acrylic particles results in easy addition to the main dope due to small adding amount. Therefore, above range of the acrylic particle is preferred.

“Side materials”, as described herein, refer to ones which are produced by finely pulverizing acrylic-resin-containing films. Available ones include trimmed portions of film of both edges formed during production of acrylic-resin-containing film and mill rolls which are not within the specifications, for example, due to the presence of abrasion defects.

Further, preliminary mixed and pelletized ones of acrylic resin and cellulose ester resin and in some case acrylic particles can be preferably employed.

2) Casting Process

A casting process is one in which dope is transferred to pressurized die 30 via a solution sending pump (for example, a pressurized type quantitative gear pump) and is cast from the pressurized die slit onto the casting position on continuously moving looped metal belt 31 such as a stainless steel belt, or a rotating metal drum.

A pressurized die is preferred in which the slit shape of the metal portion of the die can be regulated to easily make the film thickness uniform. Pressurized dies include a coat hanger die and a T die, and any of these are preferably employed. The surface of metal supports is finished to be mirror surface. In order to increase the film production rate, a multilayer may be realized in such a manner that at least two pressurized dies are provided on the metal support and the dope is divided into several portions. Alternately, it is also preferable to prepare a laminated structure film via a co-casting method in which a plurality of divided dope portions is simultaneously cast.

3) Solvent Evaporating Process

A solvent evaporating process is one in which a web (namely, a dope is cast onto a casting support and the resulting dope film is called a web) is heated on the casting support, whereby solvents evaporate.

Solvents are evaporated via a method in which air is blown from the web side and/or a method in which heat is transmitted via a liquid from the reverse side, and a method in which heat is transmitted via radiant heat from both the front and reverse surfaces. Of these, the reverse surface liquid heat transmission method is preferred since higher drying efficiency is realized. Further, preferably employed are combinations of these methods. It is preferable that the web, on the support after casting, is dried on the support under an ambience of 40-100° C. In order to maintain the ambience of 40-100° C., it is preferable that airflow at the above temperature impinges the upper surface of the web, or heating is carried out via means such as infrared rays.

In view of surface quality, moisture permeability and peeling property, it is preferable to peel the web from the support within 30-120 seconds.

4) Peeling Process

A peeling process is one in which a web, from which solvents have been evaporated on the metal support, is peeled in a predetermined peeling position. The peeled web is conveyed to the following process.

Temperature in the peeling position on the metal support is preferably 10-40° C., but is more preferably 11-30° C.

The residual solvent amount while peeled in the web on the metal support is preferably in the range of 50-120% by mass in view of drying conditions and the length of the metal support. When peeled in the presence of a relatively large amount of residual solvents, the web is excessively soft, whereby flatness is deteriorated to tend to form wrinkles and longitudinal streaks caused by peeling tension. Consequently, the amount of residual solvents in the peeling position is determined via compatibility between an economical rate and quality.

The residual solvent amount in a web is defined by the following formula.

Residual solvent amount (%)=(weight of a web prior to a heat treatment—weight of the web after the heat treatment)/(weight of the web after the heat treatment)×100

Heat treatment during determination of the residual solvent amount refers to one carried out at 115° C. for one hour.

Peeling tension during peeling of film from the metal support is commonly 196-245 N/m. However, when wrinkles tend to result, it is preferable that peeling is carried out under a tension of at most 190 N/m. Further, during peeling, the lowest peeling tension is preferably at most 166.6 N, is more preferably at most 137.2 N/m, but is most preferably at most 100 N/m.

In the present invention, temperature in the peeling position on the above metal support is preferably regulated to −50−40° C., more preferably to 10-40° C., but most preferably to 15-30° C.

5) Drying and Stretching Processes

After peeling, the web is dried employing dryer 35 in which the web is alternately passed through a plurality of rollers installed in the web dryer and/or tenter stretching apparatus 34 which conveys a web while clipping both edges of the web.

In common drying means, heated air is blown onto both sides of the web. Means are also available in which heating is carried out via application of microwaves instead of air flow. Excessively rapid drying tends to deteriorate flatness of the finished film. High temperature drying is preferably carried out when the residual solvents reaches 8% by mass. Throughout the entire process, drying is carried out between about 40 to about 250° C., but is preferably carried out specifically between 40 to 160° C.

When a tenter stretching apparatus is employed, it is preferable to employ an apparatus which enables independent control of the film holding length (the distance from the holding initiation to the holding termination) at the right and the left. Further, during the tentering process, to improve flatness, it is preferable to intentionally provide zones which differ in temperature.

Further, it is also preferable to provide a neutral zone between temperature different zones so that adjacent zones result in no interference.

Stretching operation may be carried out in dividing into multiple stages. It is preferable to carry out biaxial stretching in the casting direction as well as in the lateral direction. Further, when biaxial stretching is carried out, simultaneous biaxial stretching may be employed, or it may be stepped stretching.

In the above case, “stepped” refers, for example, to a process in which it is possible to carry out sequential stretching which differs in stretching direction or in which it is possible to divide stepped stretching in the same direction and to add stretching in another direction in any of the steps. Namely, it is possible to employ, for example, the following stretching steps.

Stretching in the casting direction-stretching in the lateral direction-stretching in the casting direction-stretching in the casting direction

Stretching in the lateral direction-stretching in the lateral direction-stretching in the casting direction-stretching in the casting direction

Further, simultaneous biaxial stretching includes a case in which stretching is carried out in one direction and tension in another direction is relaxed to allow contraction. Stretching ratio of simultaneous biaxial stretching is preferably in the range of a factor of 1.01-1.5 in the lateral and longitudinal directions.

When tentering is carried out, the residual solvent amount in a web is preferably 20-100% by mass at the initiation of tentering. It is preferable that until the residual solvents in the web reaches at most 10% by mass, drying is carried out while tentering. The above residual solvent in the web is more preferably at most 5% by mass.

Drying temperature during tentering is preferably 30-150° C., is more preferably 50-120° C., but is most preferably 70-100° C.

During the tentering process, in view of enhancement of film uniformity, it is preferable that temperature distribution in the lateral direction under any ambience is small. The temperature distribution in the lateral direction during the tentering process is preferably±5° C., is more preferably±2° C., but is most preferably±1° C.

6) Winding Process

A winding process is one in which, after the residual solvent amount in the web reaches at most 2% by mass, as an acrylic-resin-containing film, the resulting web is wound by winder 37. By realizing the residual solvent amount to be 0.4% by mass, it is possible to prepare a film which exhibits excellent dimensional stability.

Commonly employed methods may be employed as a winding method, and include a constant torque method, a constant tension method, a tapered tension method, and an internal stress constant program tension control method. Any of these may be appropriately selected and employed.

The acrylic-resin-containing film of the present invention is preferably a long-roll film. In practice, its length is about 100-about 5,000 m, and it is provided in a roll shape. Further, the film width is preferably 1.3-4 m, but is more preferably 1.4-2 m.

Thickness of the acrylic-resin-containing film of the present invention is not particularly limited. When it is employed as the polarizing plate protective film, described below, the thickness is preferably 20-200 μm, is more preferably 25-100 μm, but is most preferably 30-80 μm.

[Moisture Permeability]

In the present invention, “moisture permeability” refers to a value evaluated based on a mass change (g/(m²-day)) prior to and after humidity conditioning in which a cup containing calcium chloride is covered with each film sample and sealed, and then is left stand for 24 hours under a condition of 40° C. and a relative humidity of 90%.

Herein, moisture permeability increases as temperature increases and also humidity increases. However, regardless of each condition, the magnitude relationship of moisture permeability among the films remains the same. Therefore, in the present invention, the above mass change value in an ambience of 40° C. and a relative humidity of 90% is employed for the standard.

An acrylic resin-containing film produced by the production method of the present invention can be used at least on one side. The moisture permeability of the acrylic resin-containing film of the present invention is preferably less than 850 g/(m²-day), more preferably 80-500 g/(m²-day), still more preferably 100-450 g/(m²-day). When such a film is used as a polarizing plate protective film, the durability of a polarizing plate is enhanced at high humidity or at high temperature/humidity, whereby a liquid crystal display device exhibiting high reliability can be provided.

When a polarizing plate protective film, which is not arranged between a polarizer and a liquid crystal cell, namely, is used on the outside of the liquid crystal display cell, is an acrylic resin-containing film used for the present invention, the durability of the targeted polarizing plate used for the present invention is effectively expressed.

In this case, the polarizing plate used in the present invention incorporates an acrylic resin-containing film used for the present invention arranged at least on one side of a polarizer, and preferably arranged on the outside when viewed from a liquid crystal cell. The reason is assumed as follows: on the outside of the polarizing plate, moisture is prevented from entering the polarizing plate, whereby the durability of the polarizing plate is enhanced.

The polarizing plate used for the present invention can be provided as a polarizing plate exhibiting enhanced durability in such a manner that an acrylic resin-containing film used for the present invention is arranged specifically on both sides of a polarizer. In addition, when a polarizing plate protective film containing the same acrylic resin is used on both sides of the polarizer, unfavorable properties as a flat liquid crystal display device such that the polarizing plate is curled under a humid and hot ambience can be prevented.

Further, in cases where the polarizing plate used for the present invention employs an acrylic resin-containing film used for the present invention only on one side of a polarizer and also another polarizing plate protective film with respect to the polarizer differs from the acrylic resin-containing film used for the present invention, the acrylic resin-containing film used for the present invention is arranged on the outside of the above liquid crystal cell, and a polarizing plate protective film formed of a different material is arranged on the inside thereof (between the crystal cell and the polarizer), whereby the object employed for the present invention can effectively be expressed.

In this case, it is preferable that the moisture permeability of the polarizing plate protective film of a different material used on the same inside is 2.0 times−0.0 time as large as the moisture permeability of the acrylic resin-containing film arranged on the same outside (on the outside of the polarizer when view form the liquid crystal cell), preferably 1.5 times−0.0 time from the viewpoint of the humidity and heat stability of a displayed image. As the polarizing plate protective film of a different material used on the same inside, specifically, an optical film such as a commercially available ZEONOR film (produced by Optes Co., Ltd.) formed mainly of a cyclic olefin resin, an ARTON film (produced by JSR Corp.), or an ACRYVIEWA film (produced by Nippon Shokubai Co., Ltd.) as an acrylic resin film employing a special acrylic resin may be used for a polarizing plate by combination as a polarizing plate protective film. When materials of the polarizing plate protective films arranged on both sides of the polarizer differ, curling may occur due to ambience changes. However, in this case, in the polarizing plate used for the present invention, an acrylic resin-containing film used for the present invention is arranged on the outside of the liquid crystal display cell to ensure durability, and also a polarizing plate protective film of a different material opposed to the polarizer, namely, present on the liquid crystal cell side is bonded to the substrate of the liquid crystal cell via a gluing agent, whereby the possibility of curling is prevented.

<Polarizing Plate>

A polarizing plate used for the present invention can be produced by an appropriate conventional method. It is preferable that an adhesive layer is formed on the rear side of an acrylic resin-containing film used for the present invention and then the resulting film is bonded to at least one side of a polarizer produced via immersion and stretching in an iodine solution.

For another side, the same acrylic resin-containing film or a polarizing plate protective film of another material can be used.

For example, with regard to the polarizing plate protective film arranged on the liquid crystal cell side, an acrylic resin-containing film used for the present invention or a polarizing plate protective film of a different material may have functions to expand the viewing angle and to inhibit light leakage during black display. When such a film is arranged between the polarizer and the liquid crystal cell, the display quality of viewing angle expansion and light leakage inhibition during black display can be enhanced. In this object, a so-called integrated optical film provided with both functions of a retardation film and a polarizing plate protective film may be used. Further, on the polarizing plate protective film, a film in which a liquid-crystalline compound is oriented with optical anisotropy or a film in which the orientation of a liquid-crystalline compound is fixed due to curing reaction may be used. Still further, in a constitution in which a polymer layer having optical anisotropy is placed on a polarizing plate protective film, a film may be used in which high-level optical anisotropy is combined via molecular orientation by shear application or via stretching of the substrate and the polymer layer.

Furthermore, for color shift reduction or another purpose, an optical film having small birefringence or no birefringence may be arranged.

Therefore, with regard to the polarizing plate used for the present invention, as an optical film used for the present invention, a film, falling within the range where moisture permeability is appropriately controlled, is used in which an acrylic resin-containing film is arranged on the outside of the polarizer and the liquid crystal display cell, whereby durability is enhanced; and further in polarizing plate production, even if the moisture permeability of an optical film on the opposite side of the polarizer is low compared to the same range, sealing is not completely made, whereby the moisture permeability of the acrylic resin-containing film used for the present invention is ensured at least on one side of the polarizer, and thereby dying performance required in polarizing plate production can be ensured and moisture in aqueous polyvinyl alcohol due to humidity can be dried, resulting in a preferable polarizing plate constitution due to realization of the compatibility of productivity and durability.

Further, the moisture permeability of an optical film arranged between the polarizer and the liquid crystal display cell may be a moisture permeability of the extent that no degradation occurs during storage of a polarizing plate. When no optical film arranged between the polarizer and the liquid crystal display cell is used, a polarizing plate is employable in which for example, a protective film made of PET film is present from the polarizer via a gluing agent. The reason is that when viewed from the polarizer, little moisture passes through the substrate side, and with regard to polarizer degradation, when the polarizer is bonded to the substrate, durability is almost controlled by the moisture permeability of a film arranged on the outside of the polarizer.

When a polarizing plate is produced, in the step of application of a material used for bonding, namely, a gluing agent or adhesive, a solvent, specifically a solvent mainly containing water is frequently used for uniform coating. This solvent needs to be dried in which via an optical film bonded to the polarizer, the solvent is passed from the polarizer to the outside via the optical film. When such a solvent remains, the dichroic ratio of a stretched and oriented polarizer is decreased, whereby the degree of polarization and transmittance are decreased, resulting in the possibility of light leakage. In view of the scale of moisture permeability, an optical film used in the polarizing plate used for the present invention is meant to have a moisture permeability which enables a solvent to be eliminated. An optical film having necessary moisture permeability is preferably placed at least on one side of the polarizer and may be placed on both sides thereof. However, with excessive moisture permeability, drying performance is increased in the polarizing plate production process and thereby productivity is increased. However, in use as a polarizing plate, degradation occurs due to humidity and heat. Therefore, the range of the above moisture permeability is preferable.

From such a viewpoint, the constitution used for the present invention can be considered excellent in order to miscibilize drying performance during polarizing plate production and the durability of a polarizing plate when used for a display device.

A polarizer, which is a major constitutional component of the polarizing plate, is an element which transmits light in a polarized wave plane in a specific direction. The representative polarizing film, which is presently known, is a polyvinyl alcohol based polarizing film, which includes one dyed with iodine and the other which is dyed with dichroic dyes.

The employed polarizer is prepared as follows. A film is prepared employing an aqueous polyvinyl alcohol solution. The resulting film is uniaxially stretched, followed by dying, or after dying, it is uniaxially stretched, followed by an endurance enhancing treatment, by preferably employing boron compounds.

It is preferable to employ adhesive agents used in the above adhesive layer so that at least one portion of the adhesive layer exhibits a storage elastic modulus in the range of 1.0×10⁴-1.0×10⁹ Pa at 25° C. Curing type adhesive agents are appropriately employed, which form high molecular weight compounds, or cross linking structures via various chemical reactions after coating the above adhesives, followed by adhesion.

Specific examples thereof include such as urethane based adhesive agents, epoxy based adhesive agents, aqueous polymer-isocyanate based adhesive agents, curing type adhesive agents such as a thermally cured type acrylic adhesive agent, moisture cured urethane adhesive agents, anaerbiotic adhesive agents such as polyether methacrylate types, ester based methacrylate types, or oxidation type polyether methacrylates, cyanoacrylate based “instant” adhesive agents, and acrylate and peroxide based dual liquid type “instant” adhesive agents.

The above adhesive agents may be either of a single liquid type, or of a type such that prior to use, at least two liquids are blended.

Further, the above adhesive agents may be of a solvent based type in which organic solvents are employed as a medium, of an aqueous type such as an emulsion type, a colloid dispersion type, or an aqueous solution type in which media are composed of water as a major component, or may be of a non-solvent type. Concentration of the above adhesive agent solution may be appropriately determined depending on the film thickness after adhesion, the coating method, and the coating conditions, and is commonly 0.1-50% by mass.

<Liquid Crystal Display Device>

By incorporating a polarizing plate, adhered together with the acrylic-resin-containing film of the present invention, in a liquid crystal display device, it is possible to produce a liquid crystal display device which excels in various kinds of visibility. The polarizing plate according to the present invention is adhered to liquid crystal cells via the above adhesive layer.

The polarizing plate according to the present invention is preferably employed in a reflection type, transparent type, or semi-transparent type LCD, or in various driving system LCDs such as a TN type, an STN type, an OCB type, an HAN type, a VA type (a PVA type and an MVA type), and an IPS type (including an FFS system). Specifically in a large screen display device, particularly a screen of at least 30 type, especially of 30-54 type, no white spots occur at the periphery of the screen and its effect is maintained over an extended duration.

Further, effects are realized in which color shade, glare, and wavy mottling are minimized, and eyes do not tire even when viewing over an extended duration.

### EXAMPLES

The present invention will now specifically be described with reference to examples that by no means limit the scope of the present invention.

### Example 1

Acrylic resins A1-A5 described below were produced by a well-known method.

A1: Poly(MMA-MA); mass ratio 98:2; Mw 70000

A2: Poly(MMA-MA); mass ratio 97:3; Mw 800000

A3: Poly(MMA-MA); mass ratio 97:3; Mw 930000

A4: Poly(MMA-MA); mass ratio 94:4; Mw 1100000

MMA: Methyl methacrylate

MA: Methyl acrylate

(Synthesis of A5)

Initially, a methyl methacrylate/acrylamide copolymer-based suspension agent was produced by the following method.

| | | |
|---|---|---|
| Methyl methacrylate | 20 | parts by mass |
| Acrylamide | 80 | parts by mass |
| Potassium persulfate | 0.3 | part by mass |
| Ion-exchange water | 1500 | parts by mass |

The above substances were placed in a reaction container. Then, as the space of the reaction container was substituted with nitrogen gas, reaction was allowed to progress at a maintained temperature of 70° C. until these monomers were completely converted into a polymer. The thus-obtained aqueous solution was used as a suspension agent. A solution, in which 0.05 part by mass of the above suspension agent was dissolved in 165 parts by mass of ion-exchange water, was fed into a stainless-steel autoclave of a capacity of 5 liters fitted with a baffle and a Pfaudler-type stirrer, followed by stirring at 400 rpm while the interior of the system was substituted with nitrogen gas.

Subsequently, a mixed substance having the following nominal composition was added while the reaction system was stirred.

| | | |
|---|---|---|
| Methacrylic acid | 27 | parts by mass |
| Methyl methacrylate | 73 | parts by mass |
| t-Dodecyl mercaptan | 1.2 | parts by mass |
| 2,2′-Azobisisobutylonitrile | 0.4 | part by mass |

After addition, the temperature was raised up to 70° C. Then, the moment when the internal temperature reached 70° C. was designated as the polymerization initiation point and the temperature was maintained for 180 minutes to allow polymerization to progress.

Thereafter, based on a usual method, cooling of the reaction system, polymer separation, washing, and drying were carried out to obtain a bead-shaped copolymer. The polymerization rate of this copolymer was 97% and the weight average molecular weight thereof was 130000.

This copolymer was blended with an additive, (NaOCH₃), at 0.2% by mass. Then, using a biaxial extruder (TEX30, produced by Japan Steel Works, Ltd.; L/D=44.5), intramolecular cyclization reaction was performed at a screw rotation number of 100 rpm, a raw material feed amount of 5 kg/h, and a cylinder temperature of 290° C., as purging of nitrogen was carried out from the hopper section at a flow rate of 10 L/minute, and then a pellet was produced to obtain acrylic resin A5 by 8-hour vacuum drying at 80° C. The weight average molecular weight (Mw) of acrylic resin A5 was 130000 and the Tg thereof was 140° C.

<Production of Acrylic Resin-Containing Film 1>

(Dope Liquid Composition)

| | | |
|---|---|---|
| Acrylic resin: BR85 | 70 | parts by mass |
| CAP480-20 (produced by Eastman Chemical Co.; | 30 | parts by mass |
| acyl group total substitution degree: 2.75, | | |
| acetyl group substitution degree: 0.19, propionyl | | |
| group substitution degree: 2.56; Mw = 200000) | | |
| Methylene chloride | 300 | parts by mass |
| Ethanol | 40 | parts by mass |

The above composition was sufficiently dissolved while heated to produce a dope liquid.

(Film Production of Acrylic Resin Film 1)

Using a belt casting apparatus, the above-produced dope liquid was uniformly cast onto a stainless band support at a width of 2 m at a temperature of 22° C. On this stainless band support, the solvent was evaporated until the residual solvent amount reached 100%, followed by peeling from the stainless band support at a peeling tension of 162 N/m.

The solvent was evaporated from the thus-peeled acrylic resin web at 35° C. and then the web was slit to a width of 1.6 m, followed by drying at a drying temperature of 135° C. while stretched by a factor of 1.1 in the transverse direction using a tenter. The residual solvent amount was 10% at the moment when tenter stretching was initiated.

After tenter stretching, relaxation was carried out at 130° C. for 5 minutes. Thereafter, as conveyance through the drying zones of 120° C. and 130° C. was carried out using a large number of rolls, drying was terminated, and then slitting at a width of 1.5 m was can⁻led out, followed by knurling processing of a width of 10 mm and a height of 5 μm for both film edges and by winding using a core of an inner diameter of 6 inches at an initial tension of 220 N/m and an final tension of 110 N/m to obtain acrylic resin-containing film 1.

The stretching factor of the MD direction calculated form the rotation rate of the stainless band support and the movement rate of the tenter was 1.1.

The residual solvent amount of acrylic resin-containing film 1 described in Table 1 was 0.1% and the film thickness and the winding length thereof were 60 μm and 4000 m, respectively.

Thereafter, acrylic resin-containing films 2-34 were produced in the same manner as for acrylic resin-containing film 1 except that the type and composition ratio of the acrylic resin and cellulose ester resin were changed as described in Table 1 and Table 2.

Herein, for these acrylic resin-containing films, dopes were produced by adding UV absorbents to be described later as described in Table 1 and Table 2. With regard to the added amount, based on the solid amount of a dope containing no UV absorbent (namely, the sum of an acrylic resin and a cellulose ester resin was designated as 100 parts by mass), the types listed in Table 1 and Table 2 were added at the following parts by mass and dissolved for dope preparation, whereby these films were produced as described above. Further, acrylic resin-containing film 34 was produced by a melting method.

As acrylic resin-containing film 34, a sample film-produced using a melt casting method was produced by a usual method as described below.

Acrylic resins BR85 and CAP482-20 (produced by Eastman Chemical Co.) were mixed at a ratio of 70:30 and the resulting mixture was dried at 90° C. for 2 hours using a hot air drier through which air was passed for sufficient moisture elimination. Thereafter, using a T die film melt extrusion molding machine (T die width: 500 mm) having a resin melt kneader equipped with a screw of 65 mmφ, extrusion was carried out under a condition of a melt resin temperature of 240° C. and a T die temperature of 240° C. and then stretching was carried out by a factor of 1.2 in the MD direction and by a factor of 1.2 in the TD direction for film production of acrylic resin-containing film 34. The thickness of the thus-molded film was 60 μm.

UV Absorbents

| | | |
|---|---|---|
| TINUVIN 109 (produced by Ciba Japan K.K.) | 1.5 | parts by mass |
| TINUVIN 171 (produced by Ciba Japan K.K.) | 0.7 | part by mass |
| LA-31 (produced by Adeka Corp.) | 1.5 | parts by mass |

Further, in the cellulose ester resins in Table 1 and Table 2, acyl groups of the cellulose ester resins are represented as follows: ac represents an acetyl group, p represents a propionyl group, b represents a butyryl group, bz represents a benzoyl group, and ph represents a phthalyl group.

The used materials in Table 1 and Table 2 are as follows:

| Abbreviation | Molecular Weight | Composition |
|---|---|---|
| BR52 | 85000 | MS |
| BR80 | 95000 | MMA |
| BR83 | 40000 | MMA |
| BR85 | 280000 | MMA |
| BR88 | 480000 | MMA |
| 80N | 100000 | MMA |

The abbreviations are as follows:
MS: Methyl methacrylate/styrene copolymer
MMA: Methyl methacrylate

The BR series and 80N each represent DELPET 80N (produced by Asahi Kasei Chemicals Corp.) and DIANAL BR52, BR80, BR83, BR85, BR88, and BR102 (produced by Mitsubishi Rayon Co., Ltd.).

TABLE 1

| Acrylic | Acrylic Resin (A) | | Cellulose Ester Resin (B) | | | | | | | | | |
|---|---|---|---|---|---|---|---|---|---|---|---|---|
| Resin- | | Weight Average | | | | | | | Weight Average | Composition | | |
| containing | Acrylic | Molecular | Substitution Degree | | | | | | Molecular | Ratio (parts by | | |
| Film No. | Type | Weight Mw | ac | p | b | bz | ph | Total | Weight Mw | mass) (A)/(B) | Additive | Remarks |
| 1 | BR85 | 280000 | 0.19 | 2.56 | | | | 2.75 | 200000 | 70/30 | LA-31 | Iinventive |
| 2 | | | 0.19 | 2.56 | | | | 2.75 | 200000 | 94/6 | LA-31 | Iinventive |
| 3 | | | 0.19 | 2.56 | | | | 2.75 | 200000 | 98/2 | LA-31 | Comparative |
| 4 | | | 0.19 | 2.56 | | | | 2.75 | 200000 | 52/48 | LA-31 | Iinventive |
| 5 | | | 0.19 | 2.56 | | | | 2.75 | 200000 | 48/52 | LA-31 | Iinventive |
| 6 | | | 0.19 | 2.56 | | | | 2.75 | 240000 | 70/30 | LA-31 | Iinventive |
| 7 | | | 1.08 | 1.84 | | | | 2.92 | 200000 | 35/65 | LA-31 | Iinventive |
| 8 | | | 0.19 | 2.56 | | | | 2.75 | 200000 | 27/73 | LA-31 | Comparative |
| 9 | | | 1.08 | | 1.84 | | | 2.92 | 230000 | 70/30 | LA-31 | Iinventive |
| 10 | BR52 | 85000 | 0.19 | 2.56 | | | | 2.75 | 220000 | 70/30 | LA-31 | Iinventive |
| 11 | BR85 | 280000 | 0.19 | 2.56 | | | | 2.75 | 210000 | 60/40 | LA-31 | Iinventive |
| 12 | | | 0.19 | 2.56 | | | | 2.75 | 250000 | 70/30 | LA-31 | Iinventive |
| 13 | | | 0.19 | 2.56 | | | | 2.75 | 280000 | 70/30 | LA-31 | Iinventive |
| 14 | 80N | 100000 | 0.30 | | 2.30 | | | 2.75 | 160000 | 70/30 | Tinuvin 109 + | Iinventive |
| | | | | | | | | | | | Tinuvin171 | |
| 15 | BR85 | 280000 | 1.00 | | 1.50 | | | 2.50 | 40000 | 70/30 | LA-31 | Comparative |
| 16 | | | 0.19 | 2.56 | | | | 2.75 | 70000 | 70/30 | LA-31 | Comparative |
| 17 | | | 0.19 | 2.56 | | | | 2.75 | 80000 | 70/30 | LA-31 | Iinventive |
| 18 | | | 2.00 | 0.50 | | | | 2.50 | 220000 | 70/30 | LA-31 | Comparative |
| 19 | | | 0.30 | 1.50 | | | | 1.80 | 130000 | 70/30 | LA-31 | Comparative |
| 20 | | | 1.00 | 1.50 | | | | 2.50 | 120000 | 70/30 | LA-31 | Iinventive |
| 21 | | | 1.00 | | 1.50 | | | 2.50 | 150000 | 70/30 | LA-31 | Iinventive |
| 22 | | | 0.07 | 2.50 | | | | 2.57 | 150000 | 70/30 | LA-31 | Iinventive |
| 23 | | | 1.20 | | | 1.30 | | 2.50 | 120000 | 70/30 | LA-31 | Iinventive |
| 24 | | | 1.20 | | | | 1.30 | 2.50 | 110000 | 70/30 | LA-31 | Comparative |

TABLE 2

| Acrylic | Acrylic Resin (A) | | Cellulose Ester Resin (B) | | | | | | | | | |
|---|---|---|---|---|---|---|---|---|---|---|---|---|
| Resin- | | Weight Average | | | | | | | Weight Average | Composition | | |
| containing | Acrylic | Molecular | Substitution Degree | | | | | | Molecular | Ratio (parts by | | |
| Film No. | Type | Weight Mw | ac | p | b | bz | ph | Total | Weight Mw | mass) (A)/(B) | Additive | Remarks |
| 25 | BR80 | 95000 | 0.19 | 2.56 | | | | 2.75 | 200000 | 70/30 | LA-31 | Inventive |
| 26 | BR88 | 480000 | 0.50 | 1.20 | 1.20 | | | 2.90 | 180000 | 70/30 | LA-31 | Inventive |
| 27 | BR85 | 280000 | 2.90 | | | | | 2.90 | 200000 | 70/30 | LA-31 | Comparative |
| 28 | BR83 | 40000 | 0.19 | 2.56 | | | | 2.75 | 200000 | 70/30 | LA-31 | Comparative |
| 29 | A1 | 70000 | 0.19 | 2.56 | | | | 2.75 | 200000 | 70/30 | LA-31 | Comparative |
| 30 | A2 | 800000 | 0.19 | 2.56 | | | | 2.75 | 200000 | 70/30 | LA-31 | Inventive |
| 31 | A3 | 930000 | 0.19 | 2.56 | | | | 2.75 | 200000 | 70/30 | LA-31 | Inventive |
| 32 | A4 | 1100000 | 0.19 | 2.56 | | | | 2.75 | 200000 | 70/30 | LA-31 | Comparative |
| 33 | A5 | 130000 | 0.19 | 2,56 | | | | 2.75 | 200000 | 55/45 | LA-31 | Inventive |
| 34 | BR85 | 280000 | 0.19 | 2.56 | | | | 2.75 | 200000 | 70/30 | LA-31 | Inventive |

<Preparation of Acrylic Particle (Cl)>

There were placed 38.2 liters of ion-exchange water and 111.6 g of sodium dioctylsulfosuccinate in a reaction container fitted with a reflux condenser of an internal capacity of 60 liters and then the temperature was raised up to 75° C. under nitrogen ambience with stirring at a rotation number of 250 rpm to generate a state in which no effect of oxygen practically existed. Then, 0.36 of APS was placed in the reaction system, followed by stirring for 5 minutes. Then, a monomer mixture containing 1657 g of MMA, 21.6 g of BA, and 1.68 g of ALMA was collectively added. After exothermic peak detection, the system was further maintained for 20 minutes to complete polymerization of an innermost hard layer.

Next, 3.48 g of APS was placed. After stirring for 5 minutes, a monomer mixture containing 8105 g of BA, 31.9 g of PEDGA (200), and 264.0 g of ALMA was continuously added over 120 minutes. After the termination of addition, the reaction system was further maintained for 120 minutes to complete polymerization of a soft layer.

Subsequently, 1.32 g of APS was placed. After stirring for 5 minutes, a monomer mixture containing 2106 g of MMA and 201.6 g of BA was continuously added over 20 minutes. After the termination of addition, the reaction system was further maintained for 20 minutes to complete polymerization of an outermost hard layer 1.

Thereafter, 1.32 g of APS was placed. After the elapse of 5 minutes, a monomer mixture containing 3148 g of MMA, 201.6 g of BA, and 10.1 g of n-OM was continuously added over 20 minutes. After the termination of addition, the reaction system was further maintained for 20 minutes, followed by temperature elevation up to 95° C. and by maintenance for 60 minutes to complete polymerization of an outermost hard layer 2.

A small amount of the thus-obtained polymer latex was collected and then the average particle diameter thereof was determined to be 0.10 μm using an absorbance method. The residual latex was placed in a 3% by mass warm aqueous solution of sodium sulfate, followed by salting out/coagulation. Thereafter, repetitive dewatering/washing and then drying were carried out to obtain an acrylic particle (Cl) of a 3-layer structure.

The above abbreviations each represent the following materials:

MMA: Methyl methacrylate

BA: n-Butyl acrylate

ALMA: Allyl methacrylate

PEGDA: Polyethylene glycol diacrylate (molecular weight: 200)

n-OM: n-Octyl mercaptan

APS: Ammonium persulfate

<Production of Acrylic Resin-Containing Film 25-1>

(Dope Liquid Composition)

| | | |
|---|---|---|
| DIANAL BR80 (produced by Mitsubishi Rayon | 66.5 | parts by mass |
| Co., Ltd.) | | |
| Cellulose ester (cellulose acetate propionate; acyl | 28.5 | parts by mass |
| group total substitution degree: 2.75, acetyl | | |
| group substitution degree: 0.19, propionyl group | | |
| substitution degree: 2.56; Mw = 100000) | | |
| Above-prepared acrylic particle (C1) | 5 | parts by mass |
| Methylene chloride | 300 | parts by mass |
| Ethanol | 40 | parts by mass |

The above composition was sufficiently dissolved while heated to produce a dope liquid.

Thereafter, acrylic resin-containing films 25-1-25-5 were produced in the same manner as the production method of acrylic resin-containing film 25 described in Table 2 except that the acrylic resin (A), the cellulose ester resin (B), the acrylic particle (C), and the composition ratio were changed as described in Table 3. The specific compositions of acrylic resin-containing films containing acrylic particles are shown in Table 3.

Herein, with regard to acrylic resin-containing films 25-1 -25-5, the following UV absorbents were further added and dissolved for dope preparation and then these films were produced.

| | | |
|---|---|---|
| TINUVIN 109 (produced by Ciba Japan K.K.) | 1.5 | parts by mass |
| TINUVIN 171 (produced by Ciba Japan K.K.) | 0.7 | part by mass |

Further, for acrylic resin-containing film 25-4, instead of acrylic particle Cl, METABLEN W-341 (produced by Mitsubishi Rayon Co., Ltd.) was used as C2, and for acrylic resin-containing film 25-5, MR-2G (produced by Soken Chemicals & Engineering Co., Ltd.) having a mono-layer structure was used as C3.

With regard to acrylic resin-containing films 25-1 -25-5 thus-obtained, confirmation was made, by the following method, on the state of a resin and an acrylic particle, namely, whether the acrylic fine particles existed in a non-uniform state with respect to the resin constituting the film or in a miscible state in the continuous layers.

As to above-produced acrylic resin-containing film 25-1, 12 g of a film sample was weighed and collected, and again dissolved in a methylene chloride/ethanol solvent of the above composition, followed by stirring. After sufficient dissolution/dispersion, filtration was carried out using PTFE-made made membrane filter T010A having a pore diameter of 0.1 μm (produced by Advantec Co.) and the thus-filtered insoluble substance was sufficiently dried and the weight was determined to be 1.8 g.

Further, this insoluble substance was again dispersed in the solvent and then particle distribution was determined using a MARVERN (produced by Malvern Instruments Ltd.). As a result, the distribution thereof was observed in the vicinity of 0.10-0.20 μm.

The above result made it clear that at least 90% by mass of the added acrylic particle (C) existed as fine particles.

In the same manner, the same determination was made with respect to acrylic resin-containing films 25-2-25-5, whereby acrylic particles were confirmed to be similarly present.

TABLE 3

| Acrylic Resin- | Composition Ratio | | |
|---|---|---|---|
| containing | (parts by mass) | Acrylic | |
| Film No. | (A)/(B)/(C) | Particle | Particle Structure |
| 25 | 70/30/— | — | 3-layer core shell |
| 25-1 | 66.5/28.5/5 | C1 | 3-layer core shell |
| 25-2 | 69.9/29.9/0.2 | C1 | 3-layer core shell |
| 25-3 | 56/24/20 | C1 | 3-layer core shell |
| 25-4 | 66.5/28.5/5 | C2 | 3-layer core shell |
| 25-5 | 66.5/28.5/5 | C3 | mono-layer |

<<Evaluation Method>>

As described below, there were evaluated above-obtained acrylic resin-containing films 1-34, 25-1-25-5, as well as Konica Minolta TAC KC4UY (hereinafter referred to also as 4UY) (produced by Konica Minolta Opto, Inc.) and an alicyclic olefin resin film (ZEONOR described in Table 4) to be described later, and the results are shown in Table 4 and Table 5.

Using a simultaneous biaxial stretcher, a film having a thickness of 200 μm made of an alicyclic olefin resin (glass transition temperature: 136° C.) (ZEONOA FILM ZF-14, produced by Optes Co., Ltd.) was subjected to simultaneous biaxial stretching at an oven temperature (pre-heating temperature, stretching temperature, and heat fixing temperature) of 138° C., a film unwinding rate of 1 m/minute, a longitudinal stretching factor of 1.45, and a transverse stretching factor of 1.35 to obtain an alicyclic olefin resin film of a thickness of 100 μm. The optical retardation of the film was determined based on the conventional method. Retardation can be determined in such a manner that for example, under an ambience of 23° C. and 55% RH, using a light source of 590 nm, an average refractive index of materials constituting a film is determined with Abbe refractometer 4T, and then the average refractive index obtained with the Abbe refractometer was input during measurement using KOBRA-21ADH (produced by Oji Scientific Instruments Co.).

The maximum refractive index was present in the transverse direction in-plane with the film. The in-pane retardation had a positive value in the transverse direction which was 5 nm. The retardation in the thickness direction was 48 nm, representing the relationship obtained by subtracting the refractive index in the film thickness from the average value of the maximum refractive index and the minimum refractive index in-plane with the film.

(Haze)

Each film sample listed in Table 1, Table 2, and Table 3 was subjected to humidity conditioning for 24 hours in an air-conditioned chamber of 23° C. and 55% RH, and then under the same condition, one film sample sheet was measured using a haze meter (NDH2000, produced by Nippon Denshoku Industries Co., Ltd.) based on JIS K-7136. The results were shown in Table 4 and Table 5.

(Tension Softening Point)

Using a TENSILON test instrument (RTC-1225A, produced by Orientec Co., Ltd.), the following evaluation was conducted.

An acrylic resin-containing film having been subjected to humidity conditioning for 24 hours in the air-conditioning chamber of 23° C. and 55% RH was cut out at a size of 120 mm (height)×10 mm (width) under the same condition, and then with pulling at a tension of 10 N, temperature elevation is continued at a temperature elevation rate of 30° C./min. Thereafter, the temperature at the moment when the tension reached 9N was measured 3 times and the average temperature was designated as the tension softening point.

(Ductile Fracture)

An acrylic resin-containing film having been subjected to humidity conditioning for 24 hours in the air-conditioning chamber of 23° C. and 55% RH was cut out at a size of 100 mm (height)×10 mm (width) under the same condition. Then, 2 foldings of mountain folding and valley folding were carried out once for each so that the film was exactly overlapped at the central portion in the longitudinal direction at a curvature radius of 0 mm and a folding angle of 180° . This evaluation was conducted 3 times for the following evaluation. Herein, breaking in this evaluation represents the state of being separated into at least 2 pieces due to breakage.

A: No breaking occurs 3 out of 3 times.

B: Breaking occurs at least once out of 3 times.

(Film Moisture Permeability)

[Moisture Permeability]

Based on JIS Z-0208, each film was subjected to humidity conditioning for 24 hours at 40° C. and 90% RH and then the moisture amount per unit area (g/m²) thereof was calculated using a moisture permeability test instrument. Thereafter, moisture permeability was determined from the relationship of (mass after humidity conditioning—mass prior to humidity conditioning).

TABLE 4

| Acrylic Resin- | | Tension | | Film Moisture | |
|---|---|---|---|---|---|
| containing Film | | Softening | | Permeability | |
| No. and | | Point | Ductile | g/m² · 24 h | |
| Comparative Film | Haze (%) | (° C.) | Breaking | (40° C., 90%) | Remarks |
| 1 | 0.23 | 121 | A | 316 | inventive |
| 2 | 0.23 | 106 | A | 101 | inventive |
| 3 | 0.23 | 103 | B | 73 | comparative |
| 4 | 0.28 | 131 | A | 483 | inventive |
| 5 | 0.30 | 132 | A | 521 | inventive |
| 6 | 0.27 | 120 | A | 311 | inventive |
| 7 | 0.58 | 135 | A | 821 | inventive |
| 8 | 1.24 | 136 | A | 922 | comparative |
| 9 | 0.29 | 117 | A | 279 | inventive |
| 10 | 0.29 | 122 | A | 340 | inventive |
| 11 | 0.48 | 124 | A | 415 | inventive |
| 12 | 0.34 | 118 | A | 297 | inventive |
| 13 | 0.61 | 121 | A | 311 | inventive |
| 14 | 0.29 | 120 | A | 266 | inventive |
| 15 | 0.36 | 108 | B | 232 | comparative |
| 16 | 0.28 | 117 | B | 380 | comparative |
| 17 | 0.29 | 118 | A | 351 | inventive |
| 18 | 14.20 | 100 | B | 412 | comparative |
| 19 | 2.23 | 103 | B | 414 | comparative |
| 20 | 0.41 | 124 | A | 323 | inventive |
| 21 | 0.54 | 115 | A | 317 | inventive |
| 22 | 0.51 | 116 | A | 242 | inventive |
| 23 | 0.42 | 139 | A | 297 | inventive |
| 24 | 3.32 | 110 | B | 1103 | comparative |
| 25 | 0.34 | 125 | A | 340 | inventive |
| 26 | 0.28 | 123 | A | 331 | inventive |
| 27 | 5.78 | 102 | B | 473 | comparative |
| 28 | 0.33 | 122 | B | 364 | comparative |
| 29 | 0.34 | 121 | B | 356 | comparative |
| 30 | 0.71 | 125 | A | 321 | inventive |
| 31 | 0.89 | 126 | A | 324 | inventive |
| 32 | 1.91 | 122 | A | 361 | comparative |
| 33 | 0.69 | 144 | A | 465 | inventive |
| 34 | 0.25 | 121 | A | 302 | inventive |
| 4UV | 0.42 | 178 | A | 1240 | comparative |
| ZEONOR | 0.21 | 130 | A | 1 | comparative |

TABLE 5

| Acrylic Resin- | | Tension | | Film Moisture |
|---|---|---|---|---|
| containing Film | | Softening | | Permeability |
| No. and | | Point | Ductile | g/m² · 24 h |
| Comparative Film | Haze (%) | (° C.) | Breaking | (40° C., 90%) |
| 25 | 0.34 | 125 | A | 340 |
| 25-1 | 0.36 | 124 | A | 337 |
| 25-2 | 0.33 | 125 | A | 333 |
| 25-3 | 0.48 | 130 | A | 313 |
| 25-4 | 0.37 | 124 | A | 334 |
| 25-5 | 0.37 | 123 | A | 360 |

Table 4 and Table 5 show that any of the acrylic resin-containing films according to the present invention exhibits excellence in haze, tension softening point, ductile fracture, and film moisture permeability.

<Polarizing Plate Production>

A polarizing plate, in which each film sample shown in Table 6 and Table 7 was used as a polarizing plate protective film, was produced as described below.

A long-roll polyvinyl alcohol film of a thickness of 120 μm was immersed in 100 parts by mass of an aqueous solution containing 1 part by mass of iodine and 4 parts by mass of boric acid, followed by being stretched by a factor of 5 in the conveyance direction at 50° C. and died to produce a polarizer.

In this case, with regard to the changes of the stretching temperature and humidity during polarizing film production, the temperature was 50±0.1° C. and the humidity was 95%±0.5%. The moisture percentage of the polyvinyl alcohol film prior to stretching in the conveyance direction was 33% according to the determination of the mass difference after sufficient drying at 120° C. The moisture percentage after stretching and drying was 3% according to precise measurement using a Karl-Fischer moisture meter to be described later.

Subsequently, the film of the present invention and a comparative film were prepared for one side of this polarizer and each of the surfaces to be brought into contact with the polarizer was previously surface-treated using a corona discharge treatment system (HFS-202, produced by Kasuga Denki, Inc.) under a condition of 12 W-min/m², and thereafter bonding was carried out using a urethane-based adhesive of the following composition.

<Urethane-Based Adhesive>

| | |
|---|---|
| An aqueous emulsion of a urethane resin | 100 parts by mass |
| (HYDRAN AP-20, produced by DIC Corp.) | |
| Multi-functional glycidyl ether (CR-5L, | 5 parts by mass |
| produced by DIC Corp.) | |

In bonding using a roller, an excessive amount of the adhesive and air bubbles were eliminated from the edge of a laminated material of the polarizer and polarizing plate protective films each of which was bonded to either of both sides of the polarizer to perform bonding. Bonding was carried out at a roll pressure of 20-30 N/cm² and a speed of about 2 m/minute. Subsequently, the above-bonded sample was dried for 7 minutes in a drier of 80° C., which was designated as drying step 1, to produce a polarizing plate. Further, another polarizing plate was produced in the same manner except that the drying time at 80° C. was extended from 7 minutes to 14 minutes, which was designated as drying step 2.

A polarizing plate protective film on one side is defined as a T1 side film.

At the same time, KC4UY (produced by Konica Minolta Opto, Inc.), serving as a polarizing plate protective film, was bonded to the other side of the polarizer (herein, a film bonded to this side is defined as a T2 side film) using the urethane-based adhesive to produce polarizing plate 1. In the same manner, using acrylic resin-containing films 2-34, 25-1-25-5, as well as 4UY and the above-stretched LEONOR film, polarizing plates A-2-50 each having the constitution of Table 6 and Table 7 were produced. Herein, in Table 6 and Table 7, in the columns of the T1 side and T2 side films, those containing only the numbers represent the numbers showing Acrylic Resin-containing Film Nos.

(Cutting Performance of the Polarizing Plates)

A polarizing plate was punched out to confirm deficient potions from the cutting plane. With regard to the observation method, cutting was carried out to a size used for a 15-inch diagonal liquid crystal TV set. Four sides of a cut polarizing plate were observed at a magnification of 50 using an optical microscope.

A: No deficient portion from the cutting plane is visually noted. In this case, in optical microscope observation of a magnification of 50, the total deficient length per meter satisfies a ratio of less than 1 mm based on the length of the 4 sides of the polarizer,.

B: Deficient portions from the cutting plane are visually noted slightly. In this case, in optical microscope observation of a magnification of 50, the total deficient length per meter satisfies a ratio of 1 mm—less than 3 mm based on the length of the 4 sides of the polarizer.

C: Deficient portions from the cutting plane are visually noted markedly. In this case, in optical microscope observation of a magnification of 50, the total deficient length per meter satisfies a ratio of at least 3 mm based on the length of the 4 sides of the polarizer.

The levels of A and B are practically non-problematic.

(Determination Method of the Moisture Percentage of the Polarizing Plates)

A polarizing plate was produced at the above polarizing plate step and then cut to a size fitted in a 15-inch diagonal liquid crystal TV set, followed being bonded to the side of a glass of a thickness of 1 mm having the same size as a polarizing plate used for the 15-inch diagonal liquid crystal TV set via an acrylic adhesive layer of 20 μm so that the T-2 side of the thus-cut polarizing plate was placed on the glass side. Then, the thus-assembled product was subjected to humidity conditioning for 24 hours at 23° C. and 55% RH. Thereafter, the central portion of the polarizing plate was peeled from the glass and cut out to a size of 10 mm×30 mm with the adhesive layer remaining. Using a Karl-Fischer moisture meter, the following evaluation with respect to the moisture percentage of the polarizing plate according to drying step 1 was conducted in which the polarizing plate with the adhesive layer was placed in a heating furnace of 150±1° C. and nitrogen gas bubbling (200 ml/minute) was carried out for determination.

Subsequently, the moisture percentage of a polarizing plate produced in drying step 2 was determined in the same manner and the following evaluation with respect to the moisture percentage of the polarizing plate according to drying step 2 was conducted. The evaluation criteria are as follows:

A: The moisture content of a polarizing plate with an adhesive layer is less that 3%.

B: The moisture content of a polarizing plate with an adhesive layer is 3%—less than 5%.

C: The moisture content of a polarizing plate with an adhesive layer is at least 5%.

Further, as a comparative sample, a sheet of a commercially available ZEONOR film (ZF-14) of a thickness of 100 μm was bonded to a glass via an adhesive layer, and then subjected to humidity conditioning for 24 hours at 23° C. and 55% RH. Thereafter, determination was conducted in the same manner as in the moisture percentage determination of the polarizing plate, whereby the moisture content of the film with an adhesive layer of 20 μm was 0.2%. On the other hand, conducted was determination only on the ZEONOR film having been subjected to 24-hour humidity conditioning at 23° C. and 55% RH. Thereby, the moisture percentage thereof was 0.0%. Therefore, in the determination, a change of 0.2% at one decimal place can result from the adhesive layer. Accordingly, the change of the moisture content of the polarizing plate was evaluated in such a manner that a value obtained by subtracting 0.2% from a determined value of the moisture content was considered to represent a change in the polarizing plate itself except the adhesive layer.

<Polarizer Degradation >

Initially, the parallel transmittance and the orthogonal transmittance of a polarizing plate produced by the above method were determined using a UV2200 spectrophotometer (produced by Shimadzu Corp.) to calculate the degree of polarization based on the following expression. Thereafter, each polarizing plate was subjected to enforced degradation for 1000 hours under a condition of 60° C. and 90% and then the parallel transmittance and the orthogonal transmittance were determined again to calculate the degree of polarization based on the following expression. The amount of change in the degree of polarization was obtained by the following expression.

The degree of polarization P=((H₀-H₉₀)/(H₀+H₉₀))^{0.5}×100

The amount of change in the degree of polarization−P₀-P₁₀₀₀

H₀: parallel transmittance

H₉₀: orthogonal transmittance

P₀: the degree of polarization prior to enforced degradation

P₁₀₀₀: the degree of polarization after 1000-hour enforced degradation

The wavelength of the visible region was defined as 400 nm-700 nm and then the amount of change in the degree of polarization in the visible region was determined with respect to each polarizing plate sample. Then, the change of the degree of polarization was evaluated based on the following criteria.

Herein, polarizer degradation 1 represents the evaluation result of a sample treated in drying step 1 during polarizing plate production.

Polarizer Degradation 2 represents the evaluation result of a sample treated in drying step 2 during polarizing plate production.

A: The amount of change in the degree of polarization in every wavelength of the visible region is less than 3%.

B: Portions of a large amount of change in the degree of polarization in the visible region are 3%—less than 8%, which satisfies the practical level as a polarizing plate.

C: The amount of change in the degree of polarization in a portion or every portion of the visible region is at least 8%.

The levels of B and A are practically non-problematic.

A polarizer according to drying step 1 has the same moisture percentage as a polarizer according to drying step 2, or is a sample having a larger moisture percentage. In carrying out the step, shortening of the drying zone in the production line can save the investment of the plant facilities or enhance the rate to convey the zone with the same drying capacity, or being able to contribute to energy savings via drying with a small amount of heat and then to enhancement of productivity of polarizing plates.

When the moisture percentage of a polarizing plate is large, the interaction between oriented polyvinyl alcohol and iodine is decreased due to the presence of moisture, whereby dichroic ratio is considered to decrease. This behavior is thought to relate to the degradation test of the polarizing plate. Drying step 2 requires a longer drying time than drying step 1 in production of a polarizing plate, whereby drying is assumed to further progress. Thereby, since the moisture percentage is decreased, polarizer degradation 2 is superior to polarizer degradation 1 in the polarizer degradation test. In the present invention, the meaning that an acrylic resin is allowed to be miscible with a cellulose ester resin has excellence as follows: possession of an appropriate moisture permeability which is larger than that of a common acrylic resin realizes superior characteristics, which appropriately increases the drying rate during production of a polarizing plate and can contribute to the enhancement of productivity. At the same time, an optical film used for the polarizing plate of the present invention has smaller moisture permeability than a common cellulose resin, as well as having appropriate moisture permeability, which exhibits excellence in which enhanced durability and high productivity are combined for the polarizing plate.

<Production of Liquid Crystal Display Devices>

Using 2 sheets of the above-produced polarizing plate, display characteristics of the acrylic resin-containing film of the present invention were evaluated.

Using liquid crystal TV set WₒₒₒW32-L7000 (produced by Hitachi Ltd.), which is a horizontal electric field-type liquid crystal display device, the polarizing plates previously bonded on both sides were separated and the above-produced polarizing plate was bonded to the observation side and the backlight side via an acrylic glue of a thickness of 20 μm so that the T2 side thereof was placed on the glass surface side of the liquid crystal cell and the absorption axis thereof was in the same direction as the previously bonded polarizing plate. Thus, each liquid crystal display device was produced. Herein, the number of a liquid crystal display device is identical to the number of a polarizing plate used.

<<Evaluation Methods>>

Using above-produced liquid crystal display devices A-1-50, the following evaluations were conducted.

(Front Contrast)

Using a polarizing plate prior to punching-out and a film having been left stand for 24 hours under an ambience of 23° C. and 55% RH, a liquid crystal display device was produced as described above. The viewing angle of the liquid crystal display device was determined using EZ-Contrast 160D (produced by ELDIM Co.). In the determination method of the contrast of a liquid crystal display device produced using a polarizing plate prior to the degradation test, ranking of contrast during white display and black display of a liquid crystal panel was conducted in the normal direction with respect to the panel surface.

Further, a polarizing plate was produced in the above polarizing plate step and then cut to a size fitted in a 15-inch diagonal liquid crystal TV set. The polarizing plate was bonded to the side of a glass of a thickness of 1 mm having the same size as the polarizing plate used for the 15-inch diagonal liquid crystal TV set via an acrylic adhesive layer of 20 μm so that the T-2 side of the thus-cut polarizing plate was placed on the glass side. Then, the thus-assembled product was subjected to humidity conditioning for 24 hours at 23° C. and 55% RH.

Similarly, based on polarizing plate degradation test 1, a sample of the same type as the above polarizing plate was subjected to degradation testing in the same manner as in polarizing plate degradation test 1 except that a CRC silicone spray lubricating/releasing agent (produced by KURE Engineering, Ltd.) was sprayed on the side of the glass of a thickness of 1 mm having the same size as the polarizing plate used for the 15-inch diagonal TV set. The polarizing late after degradation treatment was separated from the glass together with the adhesive layer and cut into 2 sheets, followed by being bonded to the liquid crystal TV set (produced by Hitachi, Ltd.) in the same manner for front contrast determination, which was ranked as the contrast employing a polarizing plate after degradation testing.

A: at least 1000

B: 500—less than 1000

C: less than 500

The levels of B and A are practically non-problematic.

(Light Leakage Evaluation of the Polarizing Plates)

Using the above liquid crystal display device produced employing a polarizing plate prior to degradation testing, the cover was removed in a dark room so as for the cutting plane to be visualized and then black display was performed.

A: The screen of the liquid crystal display device shows black display when every portion is seen from the front side via the polarizing plate.

C: When the screen of the liquid crystal display device was observed from the front side, crack-like light leakage is noted in the periphery which is the cutting plane of the polarizing plate.

The above evaluation results are listed in Table 6 and Table 7.

TABLE 6

| | | | | | | | | Evaluation of Liquid | | | |
|---|---|---|---|---|---|---|---|---|---|---|---|
| | | | | | | | | Crystal Display Device | | | |
| Polarizing | | | | | | | | Contrast | | | |
| Plate and | Evaluation of Polarizing Plate | | | | | | | Use of | Use of | | |
| Liquid | | | Cutting | | | | | Polarizing | Polarizing | Light | |
| Crystal | Constitution 2 | | Performance | *1 | | Polarizer | Polarizer | Plate prior | Plate after | Leakage | |
| Display | T1 Side | T2 Side | of Polarizing | Drying | Drying | Degrada- | Degrada- | to Degradation | Degradation | Deter- | |
| Device No. | Film | Film | Plate | Step 1 | Step 2 | tion 1 | tion 2 | Testing | Testing | mination | Remarks |
| A-1 | 1 | 1 | A | A | A | A | A | A | A | A | Inventive |
| A-2 | 2 | 2 | B | A | A | A | A | A | A | B | Inventive |
| A-3 | 3 | 3 | C | B | A | C | B | A | A | C | Comparative |
| A-4 | 4 | 4 | A | A | A | A | A | A | A | A | Inventive |
| A-5 | 5 | 5 | A | A | A | A | A | A | A | A | Inventive |
| A-6 | 6 | 6 | A | A | A | A | A | A | A | A | Inventive |
| A-7 | 7 | 7 | A | A | A | B | A | A | A | A | Inventive |
| A-8 | 8 | 8 | A | B | A | C | B | C | C | A | Comparative |
| A-9 | 9 | 9 | B | A | A | A | A | A | A | B | Inventive |
| A-10 | 10 | 10 | A | A | A | A | A | A | A | A | Inventive |
| A-11 | 11 | 11 | A | A | A | A | A | A | A | A | Inventive |
| A-12 | 12 | 12 | A | A | A | A | A | A | A | A | Inventive |
| A-13 | 13 | 13 | A | A | A | A | A | A | A | A | Inventive |
| A-14 | 14 | 14 | A | A | A | A | A | A | A | A | Inventive |
| A-15 | 15 | 15 | C | A | A | A | A | A | A | C | Comparative |
| A-16 | 16 | 16 | C | A | A | A | A | A | A | C | Comparative |
| A-17 | 17 | 17 | A | A | A | A | A | A | A | A | Inventive |
| A-18 | 18 | 18 | C | A | A | A | A | A | C | C | Comparative |
| A-19 | 19 | 19 | C | A | A | A | A | A | C | C | Comparative |
| A-20 | 20 | 20 | A | A | A | A | A | A | A | A | Inventive |
| A-21 | 21 | 21 | A | A | A | A | A | A | A | A | Inventive |
| A-22 | 22 | 22 | A | A | A | A | A | A | A | A | Inventive |
| A-23 | 23 | 23 | A | A | A | A | A | A | A | A | Inventive |
| A-24 | 24 | 24 | C | A | A | C | C | C | C | C | Comparative |
| A-25 | 25 | 25 | B | A | A | A | A | A | A | B | Inventive |

*1: Moisture Percentage of Polarizing Plate

TABLE 7

| | | | | | | | | Evaluation of Liquid | | | |
|---|---|---|---|---|---|---|---|---|---|---|---|
| | | | | | | | | Crystal Display Device | | | |
| Polarizing | | | | | | | | Contrast | | | |
| Plate and | Evaluation of Polarizing Plate | | | | | | | Use of | Use of | | |
| Liquid | | | Cutting | | | | | Polarizing | Polarizing | Light | |
| Crystal | Constitution 2 | | Performance | *1 | | Polarizer | Polarizer | Plate prior | Plate after | Leakage | |
| Display | T1 Side | T2 Side | of Polarizing | Drying | Drying | Degrada- | Degrada- | to Degradation | Degradation | Deter- | |
| Device No. | Film | Film | Plate | Step 1 | Step 2 | tion 1 | tion 2 | Testing | Testing | mination | Remarks |
| A-26 | 26 | 26 | A | A | A | A | A | A | A | A | Inv. |
| A-27 | 27 | 27 | C | A | A | A | A | A | C | C | Comp. |
| A-28 | 28 | 28 | C | A | A | A | A | A | A | C | Comp. |
| A-29 | 29 | 29 | C | A | A | A | A | A | A | C | Comp. |
| A-30 | 30 | 30 | A | A | A | A | A | A | A | A | Inv. |
| A-31 | 31 | 31 | A | A | A | A | A | A | A | A | Inv. |
| A-32 | 32 | 32 | C | A | A | A | A | A | C | C | Comp. |
| A-33 | 33 | 33 | A | A | A | A | A | A | A | A | Inv. |
| A-34 | 34 | 34 | A | A | A | A | A | A | A | A | Inv. |
| A-35 | 25-1 | 25-1 | A | A | A | A | A | A | A | A | Inv. |
| A-36 | 25-2 | 25-2 | B | A | A | A | A | A | A | B | Inv. |
| A-37 | 25-3 | 25-3 | A | A | A | A | A | A | A | A | Inv. |
| A-38 | 25-4 | 25-4 | A | A | A | A | A | A | A | A | Inv. |
| A-39 | 25-5 | 25-5 | A | A | A | A | A | A | A | A | Inv. |
| A-40 | 1 | ZEONOR | A | A | A | A | A | A | A | A | Inv. |
| A-41 | 25-1 | ZEONOR | A | A | A | A | A | A | A | A | Inv. |
| A-42 | 25-2 | ZEONOR | A | A | A | A | A | A | A | A | Inv. |
| A-43 | 25-3 | ZEONOR | A | A | A | A | A | A | A | A | Inv. |
| A-44 | 25-4 | ZEONOR | A | A | A | A | A | A | A | A | Inv. |
| A-45 | 25-5 | ZEONOR | A | A | A | A | A | A | A | A | Inv. |
| A-46 | 4UY | 4UY | A | A | A | C | C | A | C | A | Comp. |
| A-47 | ZEONOR | 4UY | A | B | A | C | B | A | C | B | Comp. |
| A-48 | ZEONOR | ZEONOR | C | C | C | C | C | A | C | C | Comp. |
| A-49 | 25-1 | 1 | A | A | A | A | A | A | A | A | Inv. |
| A-50 | 25-1 | 25 | A | A | A | A | A | A | A | A | Inv. |

*1: Moisture Percentage of Polarizing Plate,
Inv.: Inventive, Comp.: Comparative

Table 6 and Table 7 show that the liquid crystal display device of the present invention exhibits enhanced front contrast, and also even in the liquid crystal display device provided with a polarizing plate after degradation testing, such excellence is expressed that the front contrast is maintained or minimal degradation occurs. Further, in the polarizing plate of the present invention, a smooth cutting plane of the polarizing plate is produced and no cracks are generated, whereby use thereof for a liquid crystal display device generates no light leakage. However, in the comparative examples, in liquid crystal display devices employing a polarizing plate exhibiting poor cutting performance, observed was light leakage with a shape in which minute cracks were generated from portions having been cut via punching-out in the periphery of the polarizing plate. The reason is thought to be that the optical film is fragile, whereby ductile fracture occurs, or when processing as a polarizing plate is carried out, a constitution with poor cutting performance is created. It is obvious that when a polarizing plate satisfying the requirements of the present invention is used, an excellent image can be displayed.

### Example 2

A polarizing plate was produced in the same manner as for the polarizing plate produced in Example 1 except that using the following method, a hard coat layer was previously provided on an acrylic resin-containing film or a comparative film used on the T1 side.

<<Production Method of a Hard Coat Layer>>

Above acrylic resin-containing film 1 was subjected to corona discharge treatment (Solid state corona treater 6KVA model produced by Pillar Co. was used at 20 m/minute and 0.375 kV-A-min/m² and the discharge frequency during treatment was 9.6 kHz and the gap clearance between the electrode and the dielectric roll was 1.6 mm). Then, hard coat layer coating liquid 1 described below was filtered using a polypropylene-made filter of a pore diameter of 0.4 μm to prepare a hard coat layer coating liquid. This liquid was coated using a microgravure coater and then dried at 90° C. Thereafter, using a UV lamp, the resulting coating layer was cured at an irradiated portion illuminance of 100 mW/cm² and an irradiation amount of 100 mJ/cm² to form hard coat layer 1 of a thickness of 10 pm and thus a hard coat film was produced.

(Hard Coat Layer Coating Liquid)

The following materials were stirred and mixed to prepare hard coat layer coating liquid 1.

| | | |
|---|---|---|
| Acrylic monomer: KAYARAD DPHA | 200 | parts by mass |
| (dipentaerythritol hexaacrylate, produced by | | |
| Nihon Kayaku Co., Ltd.) | | |
| IRUGACURE 184 (produced by Ciba Japan | 20 | parts by mass |
| K.K.) | | |
| Propylene glycol monomethyl ether | 110 | parts by mass |
| Ethyl acetate | 110 | parts by mass |
| <Back Coat Layer Composition> | | |
| UV 3300B (terminally acrylic-modified urethane | 1 | part by mass |
| oligomer, produced by Nippon Synthetic | | |
| Chemical Ind. Co., Ltd.) | | |
| C₉H₁₉—C₆H₄—(OCH₂CH₂)₁₂OH | 0.05 | part by mass |
| Toluene/methyl acetate (1/1) | 95 | parts by mass |
| Superfine particle silica | 0.2 | part by mass |
| (AEROJIL 200V, produced by Nihon | | |
| Aerosil Co., Ltd.) | | |

This back coat layer composition was coated at 7 ml/m² using an extrusion coater, and the resulting layer was dried by heating at 160° C. in a heating zone while conveyed.

A hard coat layer was arranged on an optical film arranged on the T1 side of a polarizing plate in the same manner to produce a polarizing plate in the same manner as above. The same result as in the polarizing plate of Example 1 with no hard coat layer was shown in the polarizer degradation test. The polarizing plate of the present invention exhibited excellent and enhanced durability in degradation test 1 in the same manner, regardless of the presence or absence of a hard coat layer of a thickness of 10 μm. Any polarizing plate ranked C in the judgment of polarizer degradation in Example 1 was also judged C in the same evaluation in Example 2, whereby with regard to the effect to enhance the durability of a polarizing plate by coating a thin hard coat of 10 μm, it is clear that this effect is hard to express since the hard coat layer is thin in this evaluation. When the same evaluation was conducted on the polarizing plate of the present invention having a hard coat layer with a changed thickness of 5 μm, the same effect was produced. Then, polarizing plates having a hard coat layer of a thickness of 10 μm of the present invention were subjected to humidity conditioning for 24 hours under an ambience of 23° C. and 55% RH, and pencil hardness determined with respect to every polarizing plate on the T1 side was 4H. The pencil hardness of the T1 side determined with respect to a polarizing plate in which the film on the T1 side was constituted of 4UY, a commercially available TAC film, was 2H. Further, similarly, the pencil hardness of a polarizing plate arranged with a ZEONOR film on the T1 side having an arranged hard coat layer of 10 μm was H, resulting in marked peeling of the hard coat layer from a scratched portion.

When a polarizing plate employing a polarizing plate protective film satisfying the scope of the present invention is constituted, a polarizing plate exhibiting high productivity and enhanced durability can be realized. Since a hard coat layer is thin, it is obvious that there can be realized a polarizing plate having reduced material cost, resulting in inexpensiveness and a reduced change in the thickness of a coating layer, as well as exhibiting superior durability and a tendency not to peel; and a liquid crystal display device.

### DESCRIPTION OF THE ALPHANUMERIC DESIGNATIONS

1 dissolving kettle
3, 6, 12, and 15 filters
4 and 13 stock kettles
5 and 14 liquid transporting pumps
8 and 16 circuit pipes
10 UV absorber mixing kettle
20 junction pipe
21 mixer
30 die
31 metal support
32 web
33 peeling position
34 tenter apparatus
35 roll dryer
41 particle preparing kettle
42 stock kettle
43 pump
44 filter

1. A polarizing plate using an acrylic resin-containing film at least on one side thereof, wherein
an acrylic resin (A) and a cellulose ester resin (B) are contained at a mass ratio of from 95:5 to 30:70 in a miscible state;
a weight average molecular weight Mw of the acrylic resin (A) is not less than 80000;
a total substitution degree (T) of acyl groups of the cellulose ester resin (B) is 2.00-3.00 and a substitution degree of acyl groups of a carbon number of 3-7 is 1.2-3.0; and
a weight average molecular weight Mw of the cellulose ester resin (B) is not less than 75000.

2. The polarizing plate, described in claim 1, wherein the acrylic resin-containing film contains acrylic fine particles at 0.5 to 45% by mass based on 100% of the total mass of the acrylic resin-containing film.

3. The polarizing plate of claim 1, wherein at least one of the acrylic resin-containing film is arranged on the outside of a polarizer with respect to a display element.

4. A liquid crystal display device comprising the polarizing plate of claim 1.
